(19) United States
(12) Patent Application Publication
(10) Pub. No.: US 2006/0078880 A1
(43) Pub. Date: Apr. 13, 2006

(54) Zinc finger libraries

(75) Inventors: Carlos F Barbas III, Solana Beach, CA (US); Pilar Blancafort, San Diego, CA (US)

Correspondence Address: CATALYST LAW GROUP, APC, 9710 SCRANTON ROAD, SUITE S-170, SAN DIEGO, CA, 92121, US

(73) Assignee: THE SCRIPPS RESEARCH INSTITUTE, LA JOLLA, CA (US)

(21) Appl. No.: 10/503,683

(22) PCT Filed: Feb. 7, 2003
(86) PCT No.: PCT/US03/03705

§ 371 Date: Aug. 8, 2005

Related U.S. Application Data
(60) Provisional application No. 60/354,981, filed on Feb. 7, 2002.

(51) Int. Cl. C40B 40/08; C40B 40/10

(52) U.S. Cl. 435/6; 435/7.1

(57) ABSTRACT

A library of multimeric DNA binding polypeptides is provided. Preferred such polypeptides are zinc finger protein DNA binding domains. Libraries of nucleotides encoding such polypeptides, expression vectors containing such nucleotides, cells containing any of the libraries and uses of the libraries are also provided.

### CROSS-REFERENCE TO RELATED APPLICATIONS

This application is a continuation-in-part of U.S. Provisional Patent Application No. 60/354,981, filed Feb. 7, 2002, the disclosure of which is incorporated herein by reference.

Funds used to support some of the studies disclosed herein were provided by the National Institutes of Health (CA86258). The United States Government, therefore, has certain rights in this invention.

### TECHNICAL FIELD OF THE INVENTION

The field of this invention is DNA binding polypeptides. More particularly, this invention pertains to a library of zinc finger DNA binding polypeptides and methods of making and using the library.

### BACKGROUND OF THE INVENTION

Transcriptional gene regulation plays a pivotal role in generating phenotypic diversity in complex organisms. Since a reasonable number of genomes have been sequenced, it is becoming apparent that genomes of very different organisms, like humans and fruit flies, are too similar to explain their phenotypic differences [Adams M D, et al. (2000) Science 287, 2218-20; Bentley D R, (2001) Nature 409, 942-3]. These should be explained not because of the genes per se but because of differential regulation. In model organisms like fruit flies, subtle changes either in the composition of transcription factors and or in the nature of interacting DNA sequences can account for enormous differences in phenotypes or cell functions. Thus, the ability to modify endogenous transcription can potentially be used to improve specific cell functions, to gain new functions and to introduce substantial changes in the corresponding phenotype.

The C₂—H₂ family of zinc finger (ZF) proteins have been used as a framework for the design of DNA-binding transcription factors [Pavletich, N P and Pabo, C O (1991) Science 252, 809-817; Liu, Q., et al. (1997) Proc Natl Acad Sci USA 94, 5525-5530; Kim J S, Pabo C O (1997) J Biol Chem 272, 29795-29800; Beerli, R. et al. (1998) Proc Natl Acad Sci USA 95, 14628-14633; Beerli, R. et al. (2000) Proc Natl Acad Sci USA 97, 1495-1500; Isalan M, Klug, A and Choo, Y. (2001) Nat Biotechnol 19 656-660]. ZF proteins have two important properties: DNA sequence specificity and modularity. First, the mode of interaction of each ZF with the DNA is relatively simple. In the Zif268-DNA complex and other variants of this complex, each ZF stabilizes an α-helix that interacts with three base pairs in the DNA major groove, a 5′-NNN-3′ triplet, where N represents any of the four nucleotides [Pavletich, NP and Pabo, C O (1991) Science 252, 809-817]. In the N-terminus of the recognition α-helix of the ZF, three amino acid positions, −1, +3 and +6 interact directly with the 3′, middle, and 5′ bases of the DNA triplet, respectively [Pavletich, N P and Pabo, C O (1991) Science 252, 809-817). Recently, phage selections and mutagenesis experiments yielded α-helices with exquisite specificity for each of the 5′-GNN-3′ triplets [Rebar, E J and Pabo C O (1994) Science 263, 671-673; Jamieson A C, Kim S H and Wells, J A (1994) Biochemistry 33, 5689-5695; Segal, D., Dreider, B. and Barbas III C F (1998) Proc Natl Acad Sci USA 96, 2758-2763] and most of the 5′-ANN-3′ triplets [Dreider, B., Segal D J, and Barbas III C F (2001) J Biol Chem 276: 29466-29478]. These experiments probed that the specificity of a given ZF can be modified depending on the amino acid residue in the N-terminus of the α-helix and that the nature of the interaction ZF-DNA can be explained by stereochemical rules.

Secondly, ZF proteins typically consist of an array of several ZF units or modules. In the Zif268-DNA complex, each ZF interacts with its DNA triplet using similar rules but neighboring ZFs behave as a quasi-independent units [Pavletich, N P and Pabo, C O (1991) Science 252, 809-817]. Indeed, multimodular 6 ZF proteins have been designed that are able to bind specifically 18 base pair DNA targets by the method of helix grafting, using α-helical sequences obtained by phage selections [Beerli, R. et al. (1998) Proc Natl Acad Sci USA 95, 14628-14633; Beerli, R. et al. (2000) Proc Natl Acad Sci USA 97, 1495-1500]. Given the complexity of the human genome, 6 ZF proteins are expected to specify a single binding site. Recently Beerli et al. [Beerli, R. et al. (2000) Proc Natl Acad Sci USA 97, 1495-1500] used this strategy to build 6ZF proteins able to recognize 18 bp sequences located in the promoter of the oncogenes erb-2 and erb-3. These ZF proteins were linked to an effector domain (either activator or repressor domain) and were able to regulate specifically the endogenous erb-2 and erb-3 genes in cancer cell lines [Beerli, R. et al. (2000) Proc Natl Acad Sci USA 97, 1495-1500].

Using a similar methodology, 3 ZF proteins linked to an activator domain have been designed to recognize several 9 bp sequences in the promoter sequence of the VEGF gene and human erythropoietin gene. Successful 3 ZF activators were shown to bind nucleosome-free regions of the DNA. These studies demonstrated the important role of endogenous factors, like the nucleosome accessibility, in the de novo design of transcription factors. Unfortunately, our knowledge of the endogenous factors involved in transcription of a given target gene is often limited and may explain why de novo design of ZF proteins to endogenous sites may result in poor or no regulation. First, regulation can be mediated not only by proximal promoter areas but also by sequences located several Kbp apart from the transcription start site. It is estimated that less than 5% of the human genome consist of coding regions. Some regulatory regions can be located upstream of the proximal promoter, in introns of complex genes and even in intergenic spaces. However, for the majority of genes these regulatory sequences need to be functionally characterized. Secondly, endogenous transcription factors, many of them tissue or cell-type specific, could compete for the binding site of a designed ZF protein. Third, endogenous transcription could depend on the chromatin organization of a given regulatory region.

We disclose herein a new combinatorial approach for the regulation of a large number of genes in mammalian cells that takes advantage of the endogenous microenvironment of genes. DNA binding polypeptide libraries are created by shuffling of DNA binding domains known to interact specifically with each of 5′-NNN-3′ triplets. These libraries contained a large number of transcription factors (e.g., 9177 for a trimeric library and 8.4×10⁷ for a hexameric library) that are linked to effector domains and introduced into mammalian cells using suitable vectors. A functional screening is used to amplify and select DNA binding polypeptides that regulate the gene of interest. We showed that specific regulators could be obtained for several mammalian genes. Using this technology we were able to activate an endothelial marker, VE-Cadherin, in an epidermoid cancer cell line, A431, that naturally does not express such a gene. This technology provides a functional tool to investigate regulatory regions and regulatory networks in complex genomes.

### BRIEF SUMMARY OF THE INVENTION

In one aspect, the present invention provides a library of multimeric DNA binding polypeptides. Preferably, the DNA binding polypeptides are zinc finger proteins having particular DNA binding domains. Multimeric is preferably dimeric, trimeric, quatrameric, pentameric, or hexameric. In one embodiment, at least one DNA binding polypeptide is non-naturally occurring.

Where the DNA binding polypeptide comprises a zinc finger DNA binding domain, at least one of the binding domains specifically binds to a nucleotide sequence of the formula 5′-(GNN)-3′, 5′-(CNN)-3′, 5′-(ANN)-3′, or 5′-(TNN)-3′.

In one embodiment, each multimeric DNA binding polypeptide is operatively linked to a functional moiety. The functional moiety can be an enzyme or a transcription regulating moiety such as an activator of transcription or a repressor of transcription. Preferred activators are VP16 and VP64. Preferred repressors are KRAB, MAD and SID. The individual DNA binding polypeptides are linked to each other using a peptide linker.

In another aspect, this invention provides nucleotides that encode the multimeric DNA binding polypeptides and expression vectors containing the encoding nucleotides. Exemplary expression vectors are retroviral vectors, adenoviral vectors and T-DNA vectors.

The present invention further provides collections of cells that contain the polypeptide, nucleotide and/or expression vector libraries. The cells of the collection can be plant cells, animal cells, bacterial cells, yeast cells, or human cells.

In yet another aspect, this invention provides a process of identifying a sequence of a transcriptional regulating site in a target gene in a cell. The process includes the steps of: a) transforming cells that contain the target gene with a library of nucleotides that encode a library of multimeric DNA binding polypeptides, each of which multimeric polypeptides is operatively linked to a transcription regulating moiety; b) identifying the transformed cells that have an altered expression of the target gene; c) extracting DNA from the cells of step (b); and d) sequencing the extracted DNA from step (c) to the identify the sequence of the multimeric DNA binding polypeptide that correlates with altered expression of the gene and the sequence of the transcriptional regulating site. Transforming is preferably accomplished by inserting the nucleotide library into expression vectors and transforming the cell with the vectors. Any of the libraries set forth herein can be used.

### BRIEF DESCRIPTION OF THE DRAWINGS

FIG. 1 shows, schematically a PCR shuffling method for making multimeric zinc finger protein libraries.

FIG. 2 shows, schematically, means for amplifying, selecting and using, with a retroviral vector, a multimeric DNA binding polypeptide library of this invention.

FIG. 3 shows the binding selectivity of zinc finger binding polypeptides to the target CAA.

FIG. 4 shows the binding selectivity of zinc finger binding polypeptides to the target CAC.

FIG. 5 shows the binding selectivity of zinc finger binding polypeptides to the target CAG.

FIG. 6 shows the binding selectivity of zinc finger binding polypeptides to the target CAT.

FIG. 7 shows the binding selectivity of zinc finger binding polypeptides to the target CCA.

FIG. 8 shows the binding selectivity of zinc finger binding polypeptides to the target CCC.

FIG. 9 shows the binding selectivity of zinc finger binding polypeptides to the target CCG.

FIG. 10 shows the binding selectivity of zinc finger binding polypeptides to the target CCT.

FIG. 11 shows the binding selectivity of zinc finger binding polypeptides to the target CGA.

FIG. 12 shows the binding selectivity of zinc finger binding polypeptides to the target CGC.

FIG. 13 shows the binding selectivity of zinc finger binding polypeptides to the target CGG.

FIG. 14 shows the binding selectivity of zinc finger binding polypeptides to the target CGT.

FIG. 15 shows the binding selectivity of zinc finger binding polypeptides to the target CTA.

FIG. 16 shows the binding selectivity of zinc finger binding polypeptides to the target CTC.

FIG. 17 shows the binding selectivity of zinc finger binding polypeptides to the target CTG.

FIG. 18 shows the binding selectivity of zinc finger binding polypeptides to the target CTT.

FIG. 19 shows 5′-ANN-3′-binding properties of selected zinc finger protein DNA binding domains.

FIG. 20 shows preferred zinc finger DNA binding domains that target 5′-GNN-3′ targets.

### DETAILED DESCRIPTION OF THE INVENTION

A library of multimeric DNA binding polypeptides is provided. A DNA binding polypeptide is a polypeptide that binds selectively to a specific base pair sequence in a target DNA molecule. DNA binding polypeptides are well known in the art. A preferred DNA binding polypeptide employs an α-helix as the DNA recognition element. Exemplary such DNA polypeptides are leucine zippers and zinc fingers. An especially preferred DNA binding polypeptide is a zinc finger protein.

As used herein, a zinc finger protein refers to a polypeptide which is a naturally-occurring or derivatized form of a wild-type zinc finger protein or one produced through recombination. A zinc finger protein may be a hybrid which contains zinc finger domain(s) from one protein linked to zinc finger domain(s) of a second protein, for example. The domains may be wild type or mutagenized. A polypeptide includes a truncated form of a wild type zinc finger protein. Examples of zinc finger proteins from which a polypeptide can be produced include TFIIIA and zif268. A zinc finger of this invention comprises a unique heptamer (contiguous sequence of 7 amino acid residues) within the α-helical domain of the polypeptide, which heptameric sequence determines binding specificity to a target nucleotide. That heptameric sequence can be located anywhere within the α-helical domain but it is preferred that the heptamer extend from position −1 to position 6 as the residues are conventionally numbered in the art. A polypeptide of this invention can include any β-sheet and framework sequences known in the art to function as part of a zinc finger protein.

The present disclosure is based on the recognition of the structural features unique to the Cys₂-His₂ class of nucleic acid-binding, zinc finger proteins. The Cys₂-His₂ zinc finger domain consists of a simple ββα fold of approximately 30 amino acids in length. Structural stability of this fold is achieved by hydrophobic interactions and by chelation of a single zinc ion by the conserved Cys₂-His₂ residues (Lee, M. S., Gippert, G. P., Soman, K. V., Case, D. A. & Wright, P. E. (1989) Science 245, 635-637). Nucleic acid recognition is achieved through specific amino acid side chain contacts originating from the α-helix of the domain, which typically binds three base pairs of DNA sequence (Pavletich, N. P. & Pabo, C. O. (1991) Science 252, 809-17, Elrod-Erickson, M., Rould, M. A., Nekludova, L. & Pabo, C. O. (1996) Structure 4, 1171-1180). Unlike other nucleic acid recognition motifs, simple covalent linkage of multiple zinc finger domains allows the recognition of extended asymmetric sequences of DNA. Studies of natural zinc finger proteins have shown that three zinc finger domains can bind 9 bp of contiguous DNA sequence (Pavletich, N. P. & Pabo, C. O. (1991) Science 252, 809-17, Swirnoff, A. H. & Milbrandt, J. (1995) Mol. Cell. Biol. 15, 2275-87). Whereas recognition of 9 bp of sequence is insufficient to specify a unique site within even the small genome of E. coli, polydactyl proteins containing six zinc finger domains can specify 18-bp recognition (Liu, Q., Segal, D. J., Ghiara, J. B. & Barbas III, C. F. (1997) Proc. Natl. Acad. Sci. USA 94, 5525-5530). With respect to the development of a universal system for gene control, an 18-bp address is sufficient to specify a single site within all known genomes. While polydactyl proteins of this type are unknown in nature, however, their efficacy in gene activation and repression within living human cells has recently been shown (Liu, Q., Segal, D. J., Ghiara, J. B. & Barbas III, C. F. (1997) Proc. Natl. Acad. Sci. USA 94, 5525-5530; Beerli et al., 2000, Proc. Soc. Natl. Acad. Sci. USA, 97:1495-1500).

In one aspect, this invention provides libraries of multimeric DNA binding polypeptides. As used herein, the term “multimeric” means two or more peptides operatively linked to each other. Preferred embodiments of multimeric are dimeric (two peptides), trimeric (three peptides), quatrameric (four peptides), pentameric (five peptides), and hexameric (six peptides). Operatively linked means that the individual peptides are attached to each other in a manner that allows for binding to specific sequences in a target nucleotide.

As is well known in the art, each DNA binding polypeptide binds to a specific sequence of three base pairs (5′-NNN-3′), where N is adenine (A), guanine (G), cytidine (C) or thymidine (T). Thus, a dimeric zinc finger binds to a sequence of six base pairs (5′-(NNN)₂-3′), a trimeric zinc finger to nine base pairs (5′-(NNN)₃-3′) and so on up to a hexameric zinc finger binding to a sequence of eighteen base pairs (5′-(NNN)₆-3′). The target base pairs exist as a contiguous sequence within a given nucleotide.

The library is constructed such that library members can specifically bind to any target sequence. Thus, library members are designed to bind to any 5′-(NNN)ₙ-3′ sequence, where n is an integer greater than 1. Preferably, n is an integer from 2 to about 6. In a preferred embodiment, at least one of the DNA binding polypeptides used to construct the library binds specifically to a 5′-ANN-3′, 5′-CNN-3′, 5′-GNN-3′ or 5′-TNN-3′ sequence. In one embodiment, at least one of the DNA binding polypeptides used to construct the library binds specifically to a 5′-GNN-3′ sequence. Each of the DNA binding polypeptides forming a monomeric unit of the library can be the same or different from the other DNA binding polypeptides. That is, each DNA binding polypeptide can specifically bind to the same or different base pair sequence. The order of the DNA binding polypeptides in the multimers is random.

The DNA binding polypeptides can be synthetic (modified from a naturally-occurring zinc finger protein) or a naturally-occurring zinc finger polypeptide. Naturally-occurring zinc fingers are well known in the art. Naturally-occurring zinc fingers can be obtained from any organism including plants, bacteria, yeast, and animals. Naturally-occurring zinc finger polypeptides can be screened using available data bases (e.g., BLAST) to identify binding characteristics to target nucleotide sequences.

Preferably, at least one of the DNA binding polypeptides is non-naturally occurring. More preferably, a plurality of the DNA binding polypeptides are non-naturally occurring. All the DNA binding polypeptides can be non-naturally occurring. The DNA binding polypeptides can be derived or produced from a wild type DNA binding polypeptides by truncation or expansion, or as a variant of the wild type-derived polypeptide by a process of site directed mutagenesis, or by a combination of the procedures. The term “truncated” refers to a DNA binding polypeptide that contains less that the full number of DNA binding polypeptides found in the native DNA binding polypeptides or that has been deleted of non-desired sequences. For example, truncation of the zinc finger-nucleotide binding protein TFIIIA, which naturally contains nine zinc fingers, might be a polypeptide with only zinc fingers one through three. Expansion refers to a DNA binding polypeptide to which additional DNA binding polypeptide have been added. For example, TFIIIA may be extended to 12 fingers by adding 3 zinc finger domains. In addition, truncated DNA binding polypeptides may include DNA binding polypeptides from more than one wild type polypeptide, thus resulting in a “hybrid” DNA binding polypeptides. The term “mutagenized” refers to a DNA binding polypeptide that has been obtained by performing any of the known methods for accomplishing random or site-directed mutagenesis of the DNA encoding the protein. For instance, in TFIIIA, mutagenesis can be performed to replace nonconserved residues in one or more of the repeats of the consensus sequence. Truncated zinc finger-nucleotide binding proteins can also be mutagenized. Examples of known zinc fingers that can be truncated, expanded, and/or mutagenized according to the present invention in order to inhibit the function of a nucleotide sequence containing a zinc finger-nucleotide binding motif include TFIIIA and zif268. Other DNA binding polypeptides are known to those of skill in the art.

A zinc finger protein used in a present library is known to bind to a specific 5′-NNN-3′ base pair target sequence. Such specific zinc fingers have been previously described (a summary of such fingers can be found hereinafter in the Examples). A zinc finger can be made using a variety of standard techniques well known in the art. Phage display libraries of zinc finger proteins were created and selected under conditions that favored enrichment of sequence specific proteins. Zinc finger domains recognizing a number of sequences required refinement by site-directed mutagenesis that was guided by both phage selection data and structural information. The murine Cys₂-His₂ zinc finger protein Zif268 is used for construction of phage display libraries (Wu, H., Yang, W.-P. & Barbas III, C. F. (1995) PNAS 92, 344-348).

Zif268 is structurally the most well characterized of the zinc-finger proteins (Pavletich, N. P. & Pabo, C. O. (1991) Science (Washington, D.C., 1883-) 252, 809-17, Elrod-Erickson, M., Rould, M. A., Nekludova, L. & Pabo, C. O. (1996) Structure (London) 4, 1171-1180, Swirnoff, A. H. & Milbrandt, J. (1995) Mol. Cell. Biol. 15, 2275-87). DNA recognition in each of the three zinc finger domains of this protein is mediated by residues in the N-terminus of the α-helix contacting primarily three nucleotides on a single strand of the DNA. The binding site for this three finger protein is 5′-GCGTGGGCG-′3 (finger-2 subsite is underlined). Structural studies of Zif268 and other related zinc finger-DNA complexes (Elrod-Erickson, M., Benson, T. E. & Pabo, C. O. (1998) Structure (London) 6, 451-464, Kim, C. A. & Berg, J. M. (1996) Nature Structural Biology 3, 940-945, Pavletich, N. P. & Pabo, C. O. (1993) Science (Washington, D.C., 1883-) 261, 1701-7, Houbaviy, H. B., Usheva, A., Shenk, T. & Burley, S. K. (1996) Proc Natl Acad Sci USA 93, 13577-82, Fairall, L., Schwabe, J. W. R., Chapman, L., Finch, J. T. & Rhodes, D. (1993) Nature (London) 366, 483-7, Wuttke, D. S., Foster, M. P., Case, D. A., Gottesfeld, J. M. & Wright, P. E. (1997) J. Mol. Biol. 273, 183-206., Nolte, R. T., Conlin, R. M., Harrison, S. C. & Brown, R. S. (1998) Proc. Natl. Acad. Sci. U.S.A. 95, 2938-2943, Narayan, V. A., Kriwacki, R. W. & Caradonna, J. P. (1997) J. Biol. Chem. 272, 7801-7809) have shown that residues from primarily three positions on the α-helix, −1, 3, and 6, are involved in specific base contacts. Typically, the residue at position −1 of the α-helix contacts the 3′ base of that finger's subsite while positions 3 and 6 contact the middle base and the 5′ base, respectively. To select a family of zinc finger domains recognizing the 5′-NNN-3′ subset of sequences, two highly diverse zinc finger libraries were constructed in the phage display vector pComb3H (Barbas III, C. F., Kang, A. S., Lerner, R. A. & Benkovic, S. J. (1991) Proc. Natl. Acad. Sci. USA 88, 7978-7982, Rader, C. & Barbas III, C. F. (1997) Curr. Opin. Biotechnol. 8, 503-508). Both libraries involved randomization of residues within the α-helix of finger 2 of variants of Zif268 (Wu, H., Yang, W.-P. & Barbas III, C. F. (1995) PNAS 92, 344-348).

Library 1 was constructed by randomization of positions −1,1,2,3,5,6 using a NNK doping strategy while library 2 was constructed using a VNS doping strategy with randomization of positions −2,−1,1,2,3,5,6. The NNK doping strategy allows for all amino acid combinations within 32 codons while VNS precludes Tyr, Phe, Cys and all stop codons in its 24 codon set. The libraries consisted of 4.4×10⁹ and 3.5−10⁹ members, respectively, each capable of recognizing sequences of the 5′-GCGNNNGCG-3′ type. The size of the NNK library ensured that it could be surveyed with 99% confidence while the VNS library was highly diverse but somewhat incomplete. These libraries are, however, significantly larger than previously reported zinc finger libraries (Choo, Y. & Klug, A. (1994) Proc Natl Acad Sci USA 91, 11163-7, Greisman, H. A. & Pabo, C. O. (1997) Science (Washington, D.C.) 275, 657-661, Rebar, E. J. & Pabo, C. O. (1994) Science (Washington, D.C., 1883-) 263, 671-3, Jamieson, A. C., Kim, S.-H. & Wells, J. A. (1994) Biochemistry 33, 5689-5695, Jamieson, A. C., Wang, H. & Kim, S.-H. (1996) PNAS 93, 12834-12839, Isalan, M., Klug, A. & Choo, Y. (1998) Biochemistry 37, 12026-33). Seven rounds of selection were performed on the zinc finger displaying-phage with each of the 64 5′-GCGNNNGCG-3′ biotinylated hairpin DNAs targets using a solution binding protocol. Stringency was increased in each round by the addition of competitor DNA. Sheared herring sperm DNA was provided for selection against phage that bound non-specifically to DNA. Stringent selective pressure for sequence specificity was obtained by providing DNAs of the 5′-GCGNNNGCG-3′ types as specific competitors. Excess DNA of the 5′-GCGNNNGCG-3′ type was added to provide even more stringent selection against binding to DNAs with single or double base changes as compared to the biotinylated target. Phage binding to the single biotinylated DNA target sequence were recovered using streptavidin coated beads. In some cases the selection process was repeated. The present data show that these domains are functionally modular and can be recombined with one another to create polydactyl proteins capable of binding 18-bp sequences with sub-nanomolar affinity. The family of zinc finger domains described herein is sufficient for the construction of 17 million novel proteins that bind the 5′-(GNN)₆-3′ family of DNA sequences.

A library of this invention can be made with any degree of complexity and with from 2 to 6 or more DNA binding polypeptides operatively linked to each other. Because a string of six such polypeptides targets a nucleotide sequence of 18 base pairs, libraries of greater than six linked polypeptides are typically neither desirable or necessary. The library can contain any combination of known DNA binding polypeptide sequences having a known target specificity. Thus, a library can contain only sequences known to bind to GNN, CNN, ANN or TNN. Similarly, a library can be made to contain any combination of sequences. The sequences of DNA binding polypeptides that target specific DNA nucleotide sequences are well known in the art.

A library of multimeric DNA binding polypeptides is made using PCR shuffling. First, one selects the particular DNA binding polypeptides to be used as building blocks for the library. Preferred such building blocks are zinc finger proteins having particular and defined DNA binding domains. Such zinc fingers are well known in the art (See, e.g., U.S. Pat. Nos. 6,140,081 and 6,140,466, the disclosures of which are incorporated herein by reference). In addition, the present inventors have described unique zinc fingers that specifically bind to ANN, CNN and TNN sequences (See the Examples). A nucleotide that encodes each DNA binding polypeptide (e.g., zinc finger) is then provided. The exact number of particular DNA binding polypeptide encoding sequences used depends upon the desired size of the library.

By way of example, there are 4096 transcription factors that can be assembled to recognize all the 9 bp (GNN)₃ sites and 32,768 transcription factors that can be assembled to recognize all the 9 bp (RNN)₃ sites; where R is G or A. When these domains are used to build 6-finger transcription factors that bind 18 bp sites, more than one billion transcription factors can be constructed. Using these sequence motifs we have searched the most recent human genome databases, the results of which are tabulated below. Accordingly, the six finger library of (GNN)₆ binding transcription factors optimally contains 1.6×10⁷ different (GNN)₆ proteins. This is, however, three times as many sites of this type that can be identified in the human genome as it is known. The number of available sites in the human genome is only 5×10⁶. Further using libraries of (RNN)₆ binding transcription factors provides for approximately 7 times oversampling of the genome. Practical reasons, however, limit the number of transcription factors that we can deliver using retroviral transduction to approximately 10⁷.

TABLE 1
Occurrence of GNN and RNN sites in the human genome. Target sites
for three- and six-zinc finger proteins are considered.

| target | | | | |
|---|---|---|---|---|
| sequence | (GNN)₃ | (RNN)₃ | (GNN)₆ | (RNN)₆ |
| size (nt) | 9 | 9 | 18 | 18 |
| complexity | 4096 | 32768 | 16,777,216 | 1,073,741,824 |

a) theoretical estimation:

| | | | | |
|---|---|---|---|---|
| site | 64 | 8 | 4096 | 64 |
| frequency | | | | |
| (nt) | | | | |
| number of | 93,750,000 | 750,000,000 | 1,464,844 | 93,750,000 |
| sites/human | | | | |
| genome | | | | |

b) DNA sequence database search:

| | | | | |
|---|---|---|---|---|
| number | 33,840,725 | 322,412,590 | 1,987,417 | 60,928,838 |
| sites/human | | | | |
| database | | | | |
| site | 68 | 7 | 1,158 | 38 |
| frequency | | | | |
| (nt) | | | | |

c) genome extrapolation:

| | | | | |
|---|---|---|---|---|
| number | 88,241,872 | 840,711,615 | 5,182,318 | 158,875,873 |
| sites/human | | | | |
| genome | | | | |

Complexity is defined as the number of different possible sequences of one type, e.g., 4⁶ for (GNN)₃.

a) The theoretical frequency of site occurrence is the inverse of the probability of finding a site, e.g., 4³ for (GNN)_{3.} The calculated number of sites per genome, assuming random distribution, considers both strands of the euchromatic human genome (2×3×10⁹ nt).
b) The number of sites found in the available human DNA sequence (2×1′150′498′878 nt) was obtained by searching both strands of the human database subset (em_hum:*) of the EMBL database (Release 65) with the FindPatterns program from the GCG package (Genetics Computer Group).
c) The number of sites per genome is extrapolated from size of the human sequence database to the euchromatic human genome size (3×10⁹ bp) (Venter et al., 2001).

Given that there are believed to be approximately 40,000 genes in the human genome, our proposed library approach can result in transcriptional regulators of every gene. Very recently this type of approach has been applied using retroviral delivery of ribozyme libraries to identify genes that upregulate expression of BRCA1. This approach identified Id4 as a regulator of BRCA1 following 5 rounds of FACS sorting and target gene identification using database searches based on the selected ribozymes. Thus, in principle, our proposed strategy is likely superior to a ribozyme-based search strategy since DNA binding polypeptides such as zinc finger proteins can function to 1) sterically occlude the binding site of a natural transcription factor, 2) when combined with an activation domain act to enhance target gene expression, 3) when combined with a repression domain act to silence target gene expression, and 4) transcriptions factors need only target one DNA site while ribozymes must target multiple copies of mRNA.

The collection of nucleotides encoding the individual DNA binding polypeptides is randomly divided into two or three groups depending on the desired multiplicity (e.g., trimer, hexamer) of the final library. Where the desired multiplicity is dimeric or quatrameric, two groups are used. Where the desired multiplicity is trimeric or hexameric, three groups are used. A combination of two and three groups are used to produce pentameric libraries.

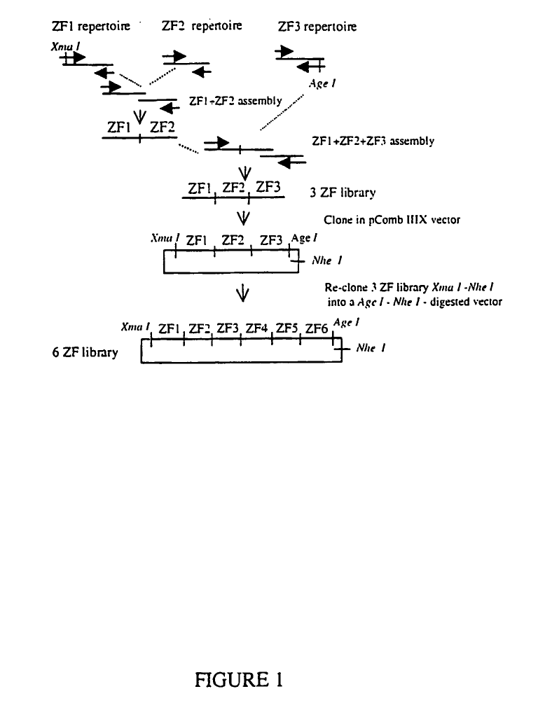

FIG. 1 shows, schematically, how PCR shuffling is used to make a trimeric (3ZF) and hexameric (6ZF) library from three groups of nucleotides encoding zinc finger proteins having particular DNA binding domains. A detailed description of the procedures can be found hereinafter in the Examples. The PCR strategy is based in a shuffling of 3 sub-libraries: ZF1, ZF2 and ZF3 using the SP1 protein sequence as a backbone. Therefore all ZFs are identical in sequence, except for the α-helical domain that provides DNA binding specificity for each DNA triplet. This strategy is based on two facts. One, ZFs can function as modular units; indeed, a given α-helix specific for a given DNA triplet can function in a context of any ZF of the protein. Two, there is a simple repertoire of α-helical domains specific for each of the 5′-GNN-3′ DNA triplets and some 5′-ANN-3′, 5′-CNN-3′ and 5′-TNN-3′ triplets. In each ZF sub-library we introduced in an equimolar ratio of more than 16 α-helices known to be specific for a given DNA triplet and tested previously in our laboratory. Combining all the available ZF1 (23), ZF2 (21) and ZF3 sequences (19) the theoretical complexity of this 3ZF library is 9177. In a cloning strategy, the 3 ZF library was used as a template to build a 6 ZF library of theoretical complexity 8.4×10⁷. If we consider the possible number of (GNN)₃ and (GNN)₆ sites in the human genome (Table 1) we expect that a given 3ZF protein from the 3ZF library (containing all the GNN specific helices) could reach more than 9000 target sites in the human genome. However, a given 6ZF protein from the library likely specifies a single site in the human genome.

Nucleotide sequences encoding specific zinc finger DNA binding domains were made. DNA sequences encoding the zinc finger-nucleotide binding polypeptides of the invention, including native, truncated, and expanded polypeptides, can be obtained by several methods. For example, the DNA can be isolated using hybridization procedures which are well known in the art. These include, but are not limited to: (1) hybridization of probes to genomic or cDNA libraries to detect shared nucleotide sequences; (2) antibody screening of expression libraries to detect shared structural features; and (3) synthesis by the polymerase chain reaction (PCR). RNA sequences of the invention can be obtained by methods known in the art (See for example, Current Protocols in Molecular Biology, Ausubel, et al. Eds., 1989).

The development of specific DNA sequences encoding zinc finger-nucleotide binding polypeptides of the invention can be obtained by: (1) isolation of a double-stranded DNA sequence from the genomic DNA; (2) chemical manufacture of a DNA sequence to provide the necessary codons for the polypeptide of interest; and (3) in vitro synthesis of a double-stranded DNA sequence by reverse transcription of mRNA isolated from a eukaryotic donor cell. In the latter case, a double-stranded DNA complement of mRNA is eventually formed which is generally referred to as cDNA. Of these three methods for developing specific DNA sequences for use in recombinant procedures, the isolation of genomic DNA is the least common. This is especially true when it is desirable to obtain the microbial expression of mammalian polypeptides due to the presence of introns.

Following library construction, the library members are amplified using any means well known in the art. By way of example, both 3ZF and 6ZF libraries were cloned in a mammalian retroviral vector pmxires GFP containing an effector domain (either VP64 for activation of genes) or SKD (for repression of genes). These libraries in the pmx vector had a complexity higher that 10⁵ for the 3ZF libraries and higher than 5×10⁷ for the 6ZF libraries. These library constructs coexpressed the GFP marker in order to quantify the expression of the ZF clones in mammalian cells. Selection follows amplification.

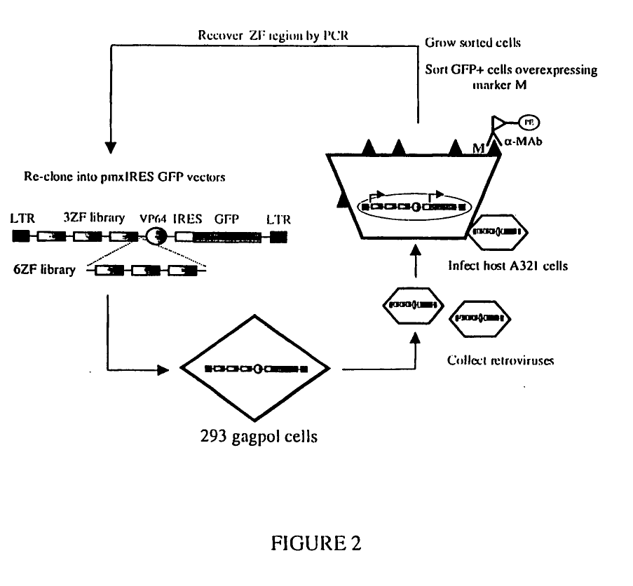

The strategy for the selection of ZF activators in human cells is represented in FIG. 2. Both 3ZF and 6ZF libraries in the retroviral vector pmxires GFP-VP64 were first transfected in the 293gagpol cell line in order to produce the viral particles. These virus were then collected and used to infect the human adenocarcinoma host cell line A431. These cells express a variety of cell surface markers M with different expression levels that can be measured by flow cytometry using specific antibodies. The fraction of GFP positive cells (thus expressing ZFs) that were overexpressing a given target gene M were sorted and re-grown. Genomic DNA was isolated and ZFs were re-amplified by PCR and re-cloned in the same pmxires GFP-VP64 vector. The selection was repeated 3 times for the 3ZF library and at least 4 times for the 6 ZF library, depending on the target gene.

In another aspect, the present invention provides a process of identifying a sequence of a transcriptional regulating site in a target gene in a cell. The process includes the steps of: a) transforming cells that contain the target gene with a library of nucleotides that encode a library of multimeric DNA binding polypeptides, each of which multimeric polypeptides is operatively linked to a transcription regulating moiety; b) identifying the transformed cells that have an altered expression of the target gene; c) extracting DNA from the cells of step (b); and d) sequencing the extracted DNA from step (c) to the identify the sequence of the multimeric DNA binding polypeptide that correlates with altered expression of the gene and the sequence of the transcriptional regulating site. Transforming is preferably accomplished by inserting the nucleotide library into expression vectors and transforming the cell with the vectors. Any of the libraries set forth herein can be used.

To test if the activation effect of the ZFs from the libraries depends on the nature and the expression level of the target gene, we tested a panel of cell surface markers and independent selection were performed for each of them and using both 3ZF and 6ZF libraries. These targets can be classed in 3 types according to their relative expression levels, measured by FACS: null expression (for example, VE-Cadherin, Prion Protein), moderate expression (for example, Erb-3, CD15) and high expression (for example, EGRF-1).

For the 3ZF-VP64 library, 4 cell surface markers, erb-2, erb-3, CD144 and CD104 yielded a progressive increase on cell surface protein levels after each round of cell sorting and re-cloning of the ZFs pools. Interestingly, all re-selected ZF pools showed an increase in GFP expression as compared to the primary library, indicating that the selected ZF were well expressed in mammalian cells and that the non-expressor clones (for example, frameshifts or toxic ZF) were discarded from the library in the early rounds of selection.

For the 6ZF library selection, two markers CD54 and CD 144 showed an increase on cell surface protein after each round of selection. These ZF pools were also GFP positive indicating significative expression in A431 cells. These experiments indicated that about 4/11 genes screened were successfully regulated using our 3 ZF library pools and that 2/10 genes tested were regulated using 6ZF library pools. Interestingly one silent gene, CD144, was activated in A431 cells using 3ZF and 3ZF and 6ZF libraries, respectively. Therefore this technology can be used not only to modulate the expression of very different genes, but also to activate dormant or silent genes in a given cell line.

In order to test the specificity of the ZF proteins, individual clones from each selection were transfected in A431 cells and cell surface protein levels were detected by FACS using a panel of different antibodies: the specificity profile of ZF clones that were able to activate CD144 (VE-Cadherin, VE-Cad). We decided to focus on this marker for three reasons; first, VE-Cad is regulatable by both 3ZF and 6 ZF library pools; secondly, the gene is silent in A431 cells. Third, it is an important endothelial-specific marker playing a crucial role in the novo formation of vascular networks or angiogenesis.

The sequences of the 3ZF and 6ZF regulating VE-Cad are presented in Tables 2 and 3, below.

TABLE 2

CD144 three-zinc finger protein activator clones.
The DNA interacting helices are presented with the
predicted 9bp target site. The fold activation of
the endogenous VE-cadherin gene is shown.

| | | |
|---|---|---|
| ZINC | | |
| | FINGER | PREDICTED |

| | | | |
|---|---|---|---|
| ZFP- | HELICES a) | TARGET | PE/ |

| | | | | |
|---|---|---|---|---|
| VP64 | F3 F2 F1 | SITES b) | EGFP c) | #d) |

| | | | | |
|---|---|---|---|---|
| VE-1 | REDNLHT RSDKLVR QSSNLVR | 5′-TAG GGG GAA-3′ | 80x/4X | 2x |
| VE-5 | RSDKLVR TSGNLVR QRANLRA | 5′-GCG GAT AAA-3′ | 4X/8X | |
| VE-8 | RSDKLVR QSSNLVR QRANLRA | 5′-GGG GAA AAA-3′ | 30X/18X | |
| VE-13 | TSGSLVR QSSNLVR RSDNLVR | 5′-GTT GAA GAG-3′ | 5X/3X | |
| VE-18 | TSGHLVR QAGHLAS RSDDLVR | 5′-GGT TGA GCG-3′ | 7x/10X | |

a) zinc finger helices are positioned in the anti-parallel orientation (COOH-F6 to F1-NI12) relatively to the DNA target sequence. Amino acid position −1 to +6 of each DNA recognition helix is shown.
b) predicted target DNA sequences are presented in the 5′ to 3′ orientation.
c) fold change of expression from FACS data is determined relatively to unspecific zinc finger activator (3 ZF-VP64 library).
d) #represents the number of independent clones having the same DNA sequence.

TABLE 3

The sequence of the six-zinc finger protein activator clones. The DNA interacting helices
arc presented with the predicted 18bp target site. The fold activation of the endogenous
gene is shown.

ACTIVA-
TION c)

#

| ZFP | ZINC FINGER HELICES a) | PREDICTED TARGET SITES b) | VE-cad/ | clones |
|---|---|---|---|---|
| VP64 | F6 F5 F4 F3 F2 F1 | Half-site 1 Half-site 2 | GFP | d) |

| | | | | | |
|---|---|---|---|---|---|
| EGRF1-1 | QSGDLRR RSDKLVR QRANLRA DPGALVR QRANLRA RSDVLVR | 5′-GCA GGG AAA - GTC AAA GTG-3′ | −4x/3.5x | | |
| CD54-2 | QSSSLVR TSGHLVR TSGSLVR DPGHLVR TSGNLVR RSDDLVR | 5′-GTA GGT GTT - GGC GAT GCG-3′ | 2.5x/10x | | |
| CD54-3 | QRANLRA TSGHLVR QRANLRA DCRDLAR RSDKLVF QSSSLVR | 5′-GAC GGT AAA - GCC GGG GTA-3′ | 2x/3x | 7. | 10 |
| CD54-13 | DPGNLVR TSGHLVR QRANLRA DCRDLAR RSDKLVR QSSSLVR | 5′-GAC GGT AAA - GCC GGG GTA-3′ | 2x/3x | 14 | |
| CD144-3 | QSSSLVR TSGHLVR RSDHLTT QSSHLVR QLAHLRA QSSHLVR | 5′-GTA GGT TGG - GAA AGA GGA-3′ | 8x/10x | 10 | |
| CD144-4 | QAGBLAS RSDDLVR TSGELVR QAGHLAS RSDKLVR DPGALVR | 5′-TGA CCC GCT - TGA GGG GTC-3′ | 100x/8x | | |
| CD144-5 | TSGELVR QLAHLRA QSGDLRR TSGSLVR DPCWLVR QSSNLAS | 5′-GCT ACA GCA - GTT GAC TAA-3′ | 20x/3.5 | | |
| CD144-13 | QSGDLRR DPGNLVR TSGHLVR REDNLHT DPGNLVR DCRDLAR | 5′-GCA GAC GGT - TAG GAC GCC-3′ | 80x/2x | | |

a) zinc finger helices are positioned in the anti-parallel orientation (COOH-F6 to F1-N112) relatively to the DNA target sequence. Amino acid position −1 to +6 of each DNA recognition helix is shown.
b) predicted target DNA sequences are presented in the 5′ to 3′ orientation.
c) fold change of expression from FACS data is determined relatively to unspecific zinc finger activator (6 ZF-VP64 library).The GFP expression is determined relatively to the background untransfected A431 cells (autofluorescence).
d) other selected clones having the same DNA sequence

Isolated clones were able to activate VE-Cad at different levels. Surprisingly, the 6ZF clone 144-4 was able to induce expression of VE-Cadherin by two orders of magnitude. In addition, the other cell surface markers were unaffected or modified poorly compared to the induction level of VE-Cad. Therefore, the isolated ZF clones were shown to activate preferentially VE-Cad over the rest of the genes tested.

To further investigate the DNA binding specificity of these proteins, we expressed the ZFs as a C-terminal fusion with the bacterial MBP (maltose binding protein). Cell extracts and purified protein were prepared and the DNA binding specificity for each fusion was tested with different targets by ELISA. The predicted DNA binding sequence of each clone was decoded by the nature of the α-helix of each ZF. The ZF proteins were able to bind specifically to its predicted target site in vitro over a panel of non-specific sequences.

To verify that the selected ZF clones were able to regulate VE-Cad at the level of transcription, we prepared cDNA from A431 cells infected with pmx-ZF clones. The levels of VE-Cad in these cells were analyzed by RT-PCR. We used an endothelial cell line (Huvec) as a positive control for this experiment since this cell line expresses VE-Cad, and as a negative control we used uninfected A431 cells since these cells don't express any detectable VE-Cad protein product as detected by FACS. A specific VE-Cad product was detected in the A431 cells infected with the ZF constructs, indicating that these clones were able to induce VE-Cad at the level of transcription.

To verify the localization of the VE-Cad product on the cell surface of the A431 -ZF infected cells, we performed immunofluorescence experiments using a VE-Cad specific antibody. Cells containing the 144-4 6ZF activator expressed high amounts of VE-Cad product in the cell surface. These levels were comparable to the endothelial specific cell line Huvec. However, uninfected A431 cells expressed non-detectable amounts of VE-Cad in the cell surface.

Using an optimized PCR gene assembly strategy, we have prepared the 4096 transcription factors that can be assembled to recognize all the 9 bp (GNN)₃ sites. Characterization of 10 clones revealed that all expressed 3-finger proteins of the appropriate design. Our initial cloning is into our phage display vector pComb3H. Appropriate gene design then allowed us to simply isolate the 3-finger gene cassette and redone it into the plasmid containing the original 3-finger library yielding the desired 6-finger library. Cloning provided 10⁸ transformants indicating that all (GNN)₆ recognition proteins should be present in the library. Retroviral libraries of 3-finger-VP16 activators and 3-finger-KRAB and MAD repressors have already been constructed and used in very recent preliminary studies for proof-of-principle. Following transduction of the activator library into the A431 cancer lines and one round of FACS selection wherein the top 5% of erbB-3 expressing cells were sorted (all levels of GFP expression were included), a pool of cells was obtained that showed correlated erbB-3 vs. GFP expression. Since GFP is an indicator of transcription factor expression in our IRES linked system, this result indicates that erbB-3 enhancing transcription factors were obtained. Given that 3-finger based gene regulation is typically much weaker than that observed for 6-finger proteins that bind their target DNAs with 50 to 70 fold enhanced affinity, the degree of regulation we observe is in the range expected. Further sorting should allow for identification of the best 3-finger activators of erbB-3 in the library.

In yet another aspect, the present invention provides a method of performing phenotypic selection in a cell or organism. As set forth above, cells are transformed with a subject library and clones with particular phenotypic alterations are selected. Identification of the gene or genes associated with that phenotypic alteration is accomplished using techniques disclosed herein. The present inventors have transformed cancer cells (HeLa cells, Karposi syndrome cells and the breast cancer cell line MDA-MB-435) with the 3ZF and 6ZF libraries shown herein. (See Table 4, below).

TABLE 4

ZF sequences selected for taxol resistance in HeLa cells. The predicted 18 base
pair DNA binding site (6ZF library selections, upper table) and 9 base pair
binding site (3ZF library selections, lower table) are indicated.

| | a) ZF HELICIS | b) PREDICTED TARGET SITES |
|---|---|---|
| TFs_{7F} | F6 F5 F4 F3 F2 F1 | Half-site 1 Half-site 2 |

| | | |
|---|---|---|
| 6ZF-1-tax^{r} | DPGNLVR QAGHLAS QSSNLAS TSGNLVR DCRDLAR RSDVLVR | 5′-GAC TGA TAA - GAT GCC GTG-3′ |
| 6ZF-5-tax^{r} | QAGHLAS QAGHLAS RSDHLTT DPGALVR RSDVLVR SDHLTNH | 5′-TGA GCG GCT - TGA GGG GTC-3′ |
| 6ZF-8-tax^{r} | RSDNLVR QAGHLAS QSSNLAS QSSNLVR TSGNLVR DPGHLVR | 5′-GAG TGA TGA - GAA GAT GGC-3′ |
| 6ZF-20-tax^{r} | QAGHLAS QSGDLRR TSGSLVR QAGHLAS DCRDLAR QRANLRA | 5′-TGA GCA GTT - TGA GCC AAA-3′ |
| 6ZF-24-tax^{r} | QSGDLRR TSGNLVR QSSNLAS DPGHLVR TSGLILV QSSNLAS | 5′-GCA GAT TAA - GGC GGT TAA-3′ |
| 6ZF-30-tax^{r} | QSSNLVR QRAHLER TSGELVR RSDDLVR TSGNLVR RSDKLVR | 5′-GAA GGA GCT - GCG GAT GGG-3′ |
| 3ZF-1-tax^{r} | QSSHLVR TSGSLVR RSDTSSN | 5′-GGA GTT AAG-3′ |
| 3ZF-5-tax^{r} | REDNLHT TSGSLVR RSDNLVR | 5′-TAG GTT GAG-3′ |
| 3ZF-6-tax^{r} | QSSSLVR QSSNLVR QSSHLVR | 5′-GTA GAA GGA-3′ |
| 6ZF-16-tax^{r} | TSGSLVR RSDTLSN RSDNLVR | 5′-GTT AAG GAG-3′ |

a) ZF helices are positioned in the anti-parallel orientation (COOH-F6 to F1-N112) relatively to the DNA targct sequence. Amino acid position −1 to +6 of each DNA recognition helix is shown. 144-clones are 6ZF proteins, VE-clones are 3ZF proteins.
b) predicted target DNA sequences are presented in the 5′ to 3′ orientation.
c) Number of clones selected having the same nucleotide sequence.

The Examples that follow illustrate preferred embodiments of the present invention and are not limiting of the specification and claims in any way.

### EXAMPLE 1

### Zinc Finger Library Construction

3ZF Library (Trimeric Library)

3 ZF library was created by overlapping PCR, mixing in the PCR reaction 23 ZF1s different DNAs, 21 ZF2s and 19 ZF3s. All DNAs used as a template for PCR were SP1 variants containing different ZF α-helices selected and characterized in our laboratory [Segal, D., Dreider, B. and Barbas III C F (1998) Proc Natl Acad Sci USA 96, 2758-2763; Dreider, B., Segal D J, and Barbas III C F (2001) J Biol Chem 276: 29466-29478.]. These templates were cloned and sequenced in pmalc2 (NEB). ZF1 library comprised α-helices specific for the triplets: 5′-GAA-3′ (helix QSSNLVR) (SEQ ID NO:1), 5′-GAC-3′ (DPGNLVR) (SEQ ID NO:2), 5′-GAG-3′ (RSDNLRR) (SEQ ID NO:3), 5′-GAT-3′ (TSGNLVR) (SEQ ID NO:4), 5′-GCA-3′ (QSGDLRR) (SEQ ID NO:5), 5′-GCC-3′ (DCRDLAR) (SEQ ID NO:6), 5′-GCG-3′ (RSDDLVR) (SEQ ID NO:7), 5′-GCT-3′ (TSGELVR) (SEQ ID NO:8), 5′-GGA-3′ (QSSHLVR) (SEQ ID NO:9), 5′-GGC-3′ (DPGHLVR) (SEQ ID NO:10), 5′-GGG-3′ (RSDKLVR) (SEQ ID NO:11), 5′-GGT-3′ (TSGHLVR) (SEQ ID NO:12), 5′-GTA-3′ (QSSSLVR) (SEQ ID NO:13), 5′-GTC-3′ (DPGALVR) (SEQ ID NO:14), 5′-GTG-3′ (RSDVLVR) (SEQ ID NO:15), 5′-GTT-3′ (TSGSLVR) (SEQ ID NO:16), 5′-AAA-3′ (QRNALAR) (SEQ ID NO:17), 5′-AAG-3′ (RKDNLKN) (SEQ ID NO:18), 5′-AGG-3′ (RSDHLTN) (SEQ ID NO:19), 5′-AAT-3′ (TTGNLTV) (SEQ ID NO:20), 5′-TGA-3′ (QAGHLAS) (SEQ ID NO:21), 5′-TAA-3′ (QSSNLAS) (SEQ ID NO:22), 5′-TGG-3′ (RSDHLTT) (SEQ ID NO:23). The ZF2 library contained the same helices for the 16 5′-GNN-3′ triplets as for ZF1 library except for the 5′-GAG-3′ triplet (RSDNLVR) (SEQ ID NO:24) and the 5′-GGA-3′ triplet (QRAHLER) (SEQ ID NO:25), and 5′-AAA-3′ (QRNALAR) (SEQ ID NO:26), 5′-AAG-3′ (RKDNLKN) (SEQ ID NO:27), 5′-AGA-3′ (QLAHLRA) (SEQ ID NO:28), 5′-TGA-3′ (QAGHLAS) (SEQ ID NO:29). The ZF3 library had the same 16 5′-GNN-3′ specific helices as described for ZF1 except for the triplet 5′-GAG-3′ (RSDNLVR) (SEQ ID NO:30), and 5′-AAA-3′ (QRNALAR) (SEQ ID NO:31), 5′-TAG-3′ (REDNLHT) (SEQ ID NO:32), and 5′-TGA-3′ (QAGHLAS) (SEQ ID NO:33). Primers used for ZF1 amplifications are FZFlib (forward): 5′-GAGGAGGAGGAGGAGGTGGCCCAGGC GGCCCTCGAGCCCGGGGAGAAGCCCTATGCTTGTCCGGAATGTGGTAAGTCC-3′ (SEQ ID NO:34) and BoverlapF1 (back) 5′-AGATTTGCCGCACTCTGGGCATTTATACGGTTTTTCACC-3′ (SEQ ID NO:35). Primers used for F2 amplifications are: FoverlapF2 (forward): 5′-GGTGAAAAACCGTA TAAATGCCCAGAGTGCGGCAAATCT-3′ (SEQ ID NO:36) and BoverlapF2 (back): 5′-GCCACATTCTGGACATTTGTATGGCTTCTCGCCAGT-3′ (SEQ ID NO:37). Primers used for ZF3 amplifications are: foverlapF3 (forward): 5′-ACTGGCGAGAAGCCATACAAATGTCCAGAATGTGGC-3′ (SEQ ID NO:38) and BZFLib (back): 5′-GAGGAGGAGGAGGAGCTGGCCGGCCTGGCCACTAGTTTT TTTACCGGTGTGAGTACGTTGGTG-3′ (SEQ ID NO:39). FZFLib and BZFLib primers introduce a SfI1 site for the cloning of the PCR fragment. PCR conditions for ZF amplifications were: 94° C. 1′ (1cycle), 94° C. 30″, 60° C. 30″ and 72° C. 30″ (25 cycles), 72° C. 10′. 1:20 of each PCR reaction (about 250 ng of each PCR product) was mixed to create the ZF1, ZF2 and ZF3 libraries. PCR was performed using the Expand High Fidelity System from Roche. The DNA was purified in 1.5% agarose gel. Overlapping PCR was performed in 2 steps: the fragment (ZF1+ZF2) was built using primers FZFlib and BoverlapF2. PCR conditions were: 100 ng ZF1s and ZF2s DNAs, 94° C. 1′ (1 cycle), 94° C. 30″, 60° C. 30″ and 72° C. 2′ (5 cycles, in absence of primers) and 15 more cycles in presence of primers, 72° C. 10′. The fragment (ZF1+ZF2)+ZF3 was built using the same conditions but using primers FZFLib and BZFLib. The final (F1+F2+F3) PCR product was SfI1 digested, gel purified in 1.5% agarose gel and cloned in several mammalian expression vectors containing different effector domains, either VP64 (activator domain) or SKD (repressor domain) [Beerli, R. et al. (2000) Proc Natl Acad Sci USA 97, 1495-1500]. First we cloned the library in pcDNA.3.1 (Invitrogen); sequences of 10 independent clones revealed a random distribution of the 33 helices and no mutation or frameshift was detected in these clones. For stable transfection of ZFs the library was cloned in a PmxIres GFP vector containing either VP64 or SKD as described in [Beerli, R. et al. (2000) Proc Natl Acad Sci USA 97, 1495-1500]. This vector allows the expression of both proteins, ZF-VP64/SKD and the GFP that is used as a marker for infection. For the pmxIres GFP-VP64 construct, 1 μg of SfI 1 digested vector was ligated with 500 ng of SfI 1 digested 3ZF-library product. The ligation product was transformed in E. coli XLblues and amplified in 200 ml of Super-broth media containing 50 μg/ml of carbicillin (SBC) [Barbas, C. F, Burton, D, Scott J K and Silverman, G. (2001) Phage Display, A Laboratory Manual, CSH Laboratory Press]. DNA was extracted using Quiagen kits. Final library size was 3.52×10⁵. For the pmxIres GFP-SKD construct 100 ng of SfI 1 vector was ligated with 50 ng of SfI 1 digested 3ZF-library, the ligation transformed in bacteria and amplified in 100 ml of SBC, the DNA extracted as described above. The final library size of 3ZF-pmxIres GFP-SKD construct was 1.7×10⁵.

6 ZF Library (Hexameric Library)

For the construction of the 6ZF library, the 3ZF library was cloned first in the vector pcom3Xss (containing 2 Sfi 1 sites). 100 ng of SfI 1 digested vector was ligated with 50 ng of 3ZF library insert digested with SfI 1. The ligation product was transformed in Xlblues and amplified in 100 ml of SBC as described above. The pcomb3Xss-3ZF library had a final size of 7.2×10⁵. To prepare the 6ZF library this vector was used as a source of both, vector (containing ZF1, ZF2 and ZF3) and insert (containing ZF3, ZF4 and ZF6) (FIG. 1). 10 μg of pcomb3X-3ZF vector digested with Age I and Nhe I was ligated with 3 mg of Xma I and Nhe I digested inserts. The ligation was transformed in electrocompetent E. coli XLBlues and amplified in 500 ml of SBC. The DNA was prepared as described above. The final library size was 1.0×10⁸. For the cloning of the 6ZF library into the pmxires GFP constructs, 2 μg of pmxires GFP-VP64 and pmxires GFP-SKD digested with SfI 1 was ligated with 1 μg of SfI 1 digested 6ZF library insert. The ligation was transformed in electrocompetent E. coli XLBlues and amplified in 500 ml of SBC. The library sizes for pmxires GFP-6ZF-VP64 construct was 5.3×10⁷ and for the pmxires GFP-6ZF-SKD vector was 8.6×10⁷.

### EXAMPLE 2

### Library Transfection

The pmxires GFP-3ZFlibrary-VP64 was transfected in 293gagpol cells (Clontech) as follows: 7.8 μg of ZF library was cotransfected with 2.5 μg of pMDG.1 vector (in order to express the Envelop protein of the retrovirus) [Beerli, R. et al. (2000) Proc Natl Acad Sci USA 97, 1495-1500] in a 15 cm tissue culture plate (VWR) per target gene. Transfection was performed using lipofectamine plus (Gibco) according to the manufacturer's instructions. A pEGFPN1 (Clontech) vector was transfected also as a control to determine the percentage of infection and pcDNA3.1 (Invitrogen) was used as a negative control for infection. After 48 hr the supernatant containing the virus was collected and used to infect A431 cells (3×10⁵ per target gene) in a 15 cm plate. Cells were collected 72 hr later for flow cytometry studies.

The pmxires GFP-6ZFlibrary-VP64 was transfected as follows. 1×10⁸ 293gagpol cells were transfected with 117 μg of 6ZF library and 39 μg of pMDG in a total of 14 T175 flasks (VWR). Transfection was performed using lipofectamine plus (Gibco) according to the manufacturer's instructions. 48 hr post-transfection the viral supernatant was used to infect a total of 1×10⁸ A431 cells distributed in 30 T175 flasks. Two days post-infection A431 cells were collected for flow cytometry studies.

### EXAMPLE 3

### Flow Cytometry

Infected A431 cells were stained with 11 different anti-human antibodies specific for A431 cell surface markers: anti-CD 15, anti-erb2 (clone SP77, [Beerli, R. et al. (2000) Proc Natl Acad Sci USA 97, 1495-1500]), anti-erb3 (clone SPG1 NeoMarkers, Fremont, Calif.), anti-CD104 (clone 450-9D), anti-CD144 (clone 55-7H1, PharMingen), anti-CD54 (clone HA58, PharMingen), anti-CD58 (clone 1C3 (AICD58.6), PharMingen), anti-CD95 (Clone DX2, PharMingen), anti-EGRF1 (Santa Cruz Biotechnology), anti-CD49f (clone GoH3, PharMingen) and anti-PrP (prion protein, a gift from Dr. Anthony Williamson at The Scripps Research Institute, only for the 3ZF library). Typically 10⁷ cells were stained in 300-500 ml of FACS-sorting buffer (FACSB, 1×PBS (metal free), 1 mM EDTA, 25 mM HEPES, pH 7.0 and 1% of calf serum (VWR) with the primary antibody at a concentration of 5 μg/ml. Cells were washed twice with FACSB and incubated with a secondary anti-human-PE antibody (PharMingen) at 1:100 dilution. Cells were washed twice in FACSB and finally resuspended in 1 ml of FACSB containing 2-5 μg of propidium iodide to measure death cells. The GFP positive and PE positive fraction of cells, as compared to negative PcDNA3.1 infected cells, was sorted using a FACS sorting device (The Scripps Research Institute). Typically, 5000-6000 cells were sorted from the 3ZF-library selection for each marker, in 1 ml of calf serum. Cells were plated then in Dulbecco's Modified Eagle Medium (DMEM) (containing 1X antibiotic-antimycotic mix from Gibco) in 10 cm plates and grown one week before the genomic DNA extraction was performed (Quiagen). For the 6ZF library selection one million GFP and PE positive A431 cells were sorted in the first round whereas 5000-6000 cells were sorted in subsequent rounds.

### EXAMPLE 4

### PCR Amplification and Re-cloning of the 3Z and 6ZF Libraries

Zinc fingers were recovered from the retrovirus integrated in the genome of A431 cells by PCR using primers pmxF2 (forward primer, 5′-TCAAAGTAGACGGCATCG-3′) (SEQ ID NO:40) and VP64AscB (back primer, 5′-TCGTCCAGCGCGCGTCGGCGCG-3′) or pMXB (back primer), 5′-CAGAATTTCGACCACTGTGC-3′ (SEQ ID NO:41). PCR was performed using typically 50 ng of genomic DNA, 94° C. 5′ (1 cycle), 94° C. 30″, 52° C. 2′ and 72° C. 2′ (3ZF library) or 3′ (6ZF library) (35 cycles), 72° C. 10′. PCR products were SfI 1-digested and cloned into the corresponding pmx vectors. Typically 20 ng of ligated product was transformed in electrocompetent E. coli XLB as described above and amplified in 10 ml of SBC. Plasmid was extracted from the cells and re-transfected into 293gagpol and then virus used to infect A431 cells. Subsequent rounds of sorting were performed identically for the 3ZF and 6ZF libraries. We transfected 3.5×10⁶ 293gagpol cells with 5 μg of total DNA (3.75 μg of pmx-ZF library vector) and 1.25 μg of pMDG) in 10 cm tissue culture plates and the viral supernatant was used to infect 10⁵ A431 cells in 10 cm plates.

### EXAMPLE 5

### Specificity Analysis of ZF Clones by FACS and DNA-Binding ELISA

Several individual pmx 3ZF and 6ZF clones isolated after sorting were transfected individually into 293gagpol cells and then the virus was used to infect A431 cells (conditions as described above for last rounds of sorting). These infected cells were analyzed by FACS with each one of the 10 (6ZF clones) or 11 (3ZF clones) antibodies described above in order to determine their target specificity. 10⁵ cells from each clone were stained with each antibody in a volume of 100 μl as described in the sorting staining procedure. Data was analyzed using CellQuest (Becton Dickinson, 1999).

The clones showing specific regulation of the target gene were sequenced using primers pmxF2 and pmxB or VP64AscB. The target site (DNA binding) specificity of each clone was determined according to the recognition rules assigned to each α-helix of each ZF (see ZF library construction). To verify this target site specificity, the ZF inserts were cloned in the vector pmalc2 and cell extracts and purified protein were produced as described [Segal, D., Dreider, B. and Barbas III C F (1998) Proc Natl Acad Sci USA 96, 2758-2763]. A DNA binding ELISA was performed using a biotinylated oligonucleotide target containing the expected binding site for each ZF clone. This target oligonucleotide forms an intra-molecular hairpin and has the general design: 5′-Biotyn-GGT(NNN)₃ AGGTTTTCCT(NNN)₃ ACC-3′ (SEQ ID NO:42), for the 3ZF target sites (where the nucleotides N and n are complementary and comprise the ZF recognition sequence) and 5′-Biotyn-GGT(NNN)₆AGGTTTTCCT(NNN)₆ ACC-3′ (SEQ ID NO:43), for the 6ZF target sites. DNA binding ELISA was performed as described [Segal, D., Dreider, B. and Barbas III C F (1998) Proc Natl Acad Sci USA 96, 2758-2763].

### EXAMPLE 6

### RNA Extraction and RT-PCR

RNA from A431 and Huvec cells (Human umbilical epithelial cells, [Clonetech]) were extracted with the Tri reagent method (MRC) according to the manufacturer's instructions. cDNA was made using RT-PCR kit from GIBCO. PCR was made using VE-Cadherin specific primers: VE-CAD-f (forward) 5′-CCGGCGCCAAAAGAGAGA-3′ (SEQ ID NO:44) and VE-CAD-b (back) 5′-CTCCTTTTCCTTCAGCTGAAGTGGT-3′ (SEQ ID NO:45) and the GAPDH specific primers (to normalize expression), GAPDH-f (forward) 5′-CCATGTTCGTCATGGGTGTGA-3′ (SEQ ID NO:46) and GAPDH-b (back) 5′-CATGGACTGTGGTCATGAGT-3′ (SEQ ID NO:47). PCR conditions were 94° C. 3′ (1 cycle), 94° C. 1′, 52° C. 2.5′ and 72° C. 2′ (35 cycles), 72° C. 5′. PCR products were visualized in a 1% for VE-Cadherin or 1.5% for the GAPDH agarose gels. The 1 Kb VE-Cadherin specific product was sequenced and shown to correspond to the expected VE-Cadherin sequence.

### EXAMPLE 7

### Immunofluorescence

To detect the VE-Cadherin product in the cell surface A431 cells transfected with the ZF clones and Huvec cells (10⁶) were collected and stained with the anti-human CD144 (anti-VE-Cadherin) antibody in 1:50 dilution. Cells were washed twice in FACS wash buffer (1×PBS (containing 1% BSA) and detected with Biotin-SP-conjugated F(ab)2 fragment and streptavidin APC. Cells were visualized using an Olympus fluorescence microscope.

### EXAMPLE 8

### Globin Gene Expression Regulation

For the selection of transcription factors that regulate δ-globin and β-globin gene expression we deliver a variety of libraries to K562 and HEL 92.1.7 cells and select for transcription factors that upregulate δ-globin and or β-globin expression and repress β-globin expression. Retroviral libraries, in pMX-IRES-GFP (Liu, Q., et al. (1997) Proc Natl Acad Sci USA 94, 5525-5530), that express the DNA binding proteins alone and in combination with activation and repression domains are studied. The libraries express DNA binding specificities for (GNN)₃, (GNN)₆, (RNN)_{6,} and (GNN)₃-(N)₃₋₉-(GNN)₃ (SEQ ID NO:48) type target sequences. Sequences of the (GNN)₃-(N)₃₋₉-(GNN)₃ (SEQ ID NO:49) type are targeted by fusing two 3-finger proteins with a designed peptide linker sequence that allows for varied spacing of the two 3-finger proteins on DNA. Chemical regulation of the transcription factors presents advantages in studies concerning functional characterization of the target genes. To accomplish this we construct K562 and HEL 92.1.7/tet-off lines and pRevTRE retroviral libraries as well.

Selection strategies. To identify zinc finger transcription factors in libraries of ˜10⁷ that specifically regulate the expression of the δ-globin and the β-globin gene, we design a novel screening strategy that allows us to easily measure the function of the designed proteins within living cells. Our screening strategy includes a specific reporter construct in which the activities of both the δ-globin and the β-globin promoters drive the expression of unique cell surface markers. Specifically, the δ-globin promoter is coupled to the coding sequence for a cell surface protein that consists of a PDGFR transmembrane domain, a HA tag, and a hapten-specific single-chain antibody (see Invitrogen 2001 catalog p. 161 for description of the cell surface protein). The activity of the δ-globin promoter is then reflected by changes in levels of the cell surface protein, which is either detected by fluorescently-labeled antibodies or selected by its binding to magnetic beads coated with hapten. Similarly, the β-globin promoter is coupled to a truncated nerve growth factor receptor, tNGFR, and detected/selected using specific antibodies:.

The expression of two unique cell surface markers allows for differential δ- vs. β-globin gene regulation to be studied as well as selected. In addition to the promoters for both δ-globin and the β-globin promoters our reporter construct also contains a minimal LCR cassette for full recapitulation of their regulation. In the construction of the reporter the same DNA fragments of the δ-globin and the β-globin promoter and the minimal LCR cassette as μLCRprRlucAprFluc are used. Several rounds of FACS based sorting allows us to clone those transcription factors that regulate δ-globin and β-globin transcription in the desired direction. The protein expression profile of the cells is then verified by HPLC or gel electrophoresis to insure that the marker was reflective of changes in endogenous gene regulation. An alternative selection strategy utilizes fixed and stained cells followed by PCR-based transcription factor recovery, recloning, and reintroduction.

Target identification. The target site of each recovered zinc finger protein is deduced based on our understanding of the predefined zinc finger domains used in the assembly process. The 18 bp target site is then used to search human genome databases to identify potential target genes. The gene is a candidate gene whose function is involved in regulating the δ-globin gene. An alternative to database discovery of the target gene is the application of DNA chips and arrays to determine the target(s). These types of experiments have been used to define the targets of natural transcription factors and could be used in our studies as well. Such studies may prove essential for identifying the targets of 9 bp binding transcription factors.

One result of these selections is the identification of a plethora of transcription factors that bind directly to the β-globin locus. These proteins allow us to further define gene regulation of this locus but may not result in the identification of unlinked modifiers. In order to prepare libraries subtracted for binding to the β-globin locus, we absorb-out proteins that bind these regions by displaying the zinc finger proteins on phage and admixing them with biotinylated-PCR products prepared from this locus. Non-bound phage then serve as a gene source for DNA binding proteins that bind to sites other than the β-globin locus. Alternatively, libraries targeting this locus can also be preselected. The discovery of new genes using our approach facilitates the development of traditional drugs to treat hemoglobinopathies as well as provide new targets for gene-therapy approaches. Further, these libraries can also be used to study the mechanism of known δ-globin gene inducers such as hydroxyurea, 5-azacytidine, and the butyrates.

### EXAMPLE 9

### GNN Zinc Finger Binding Domains

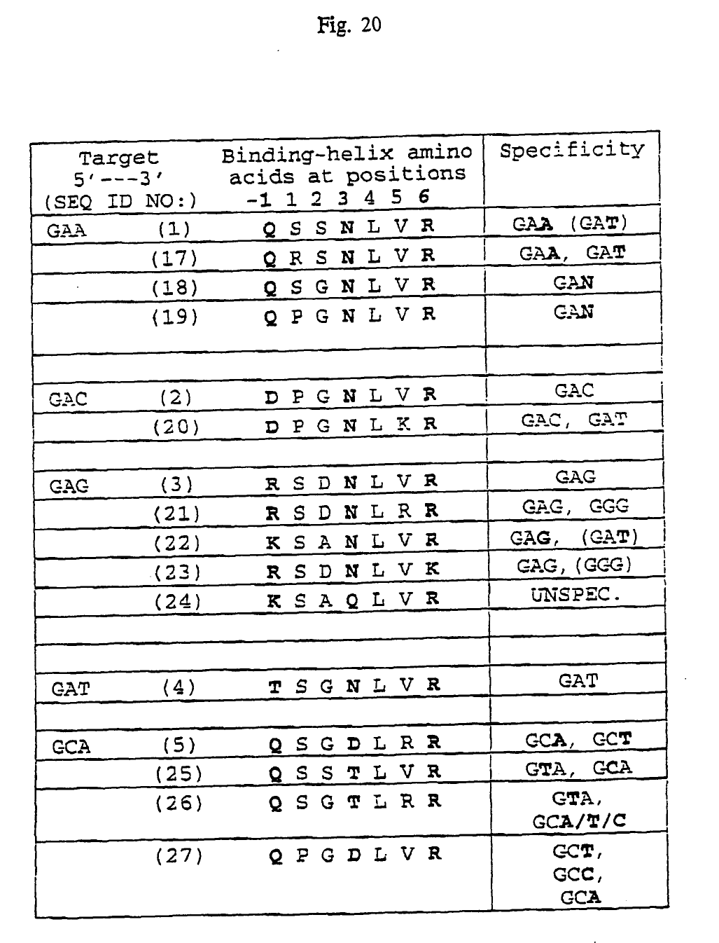

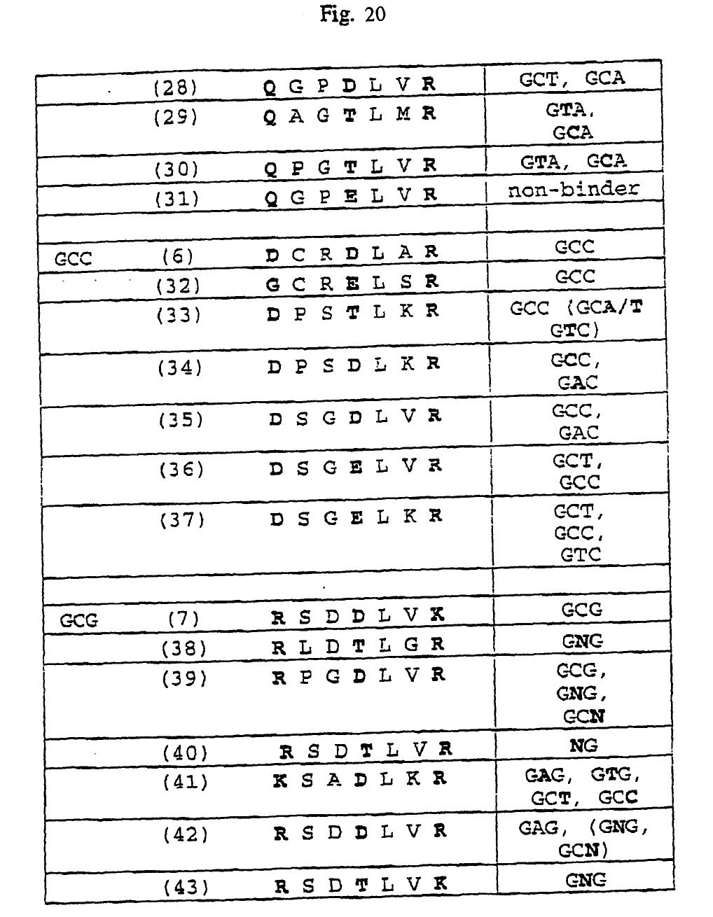

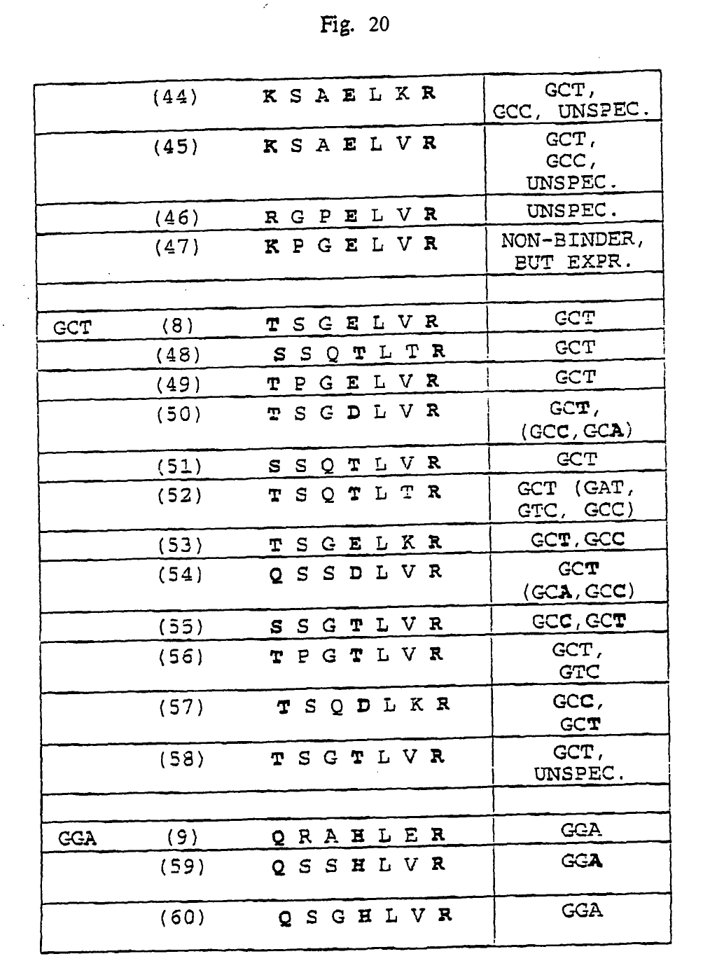

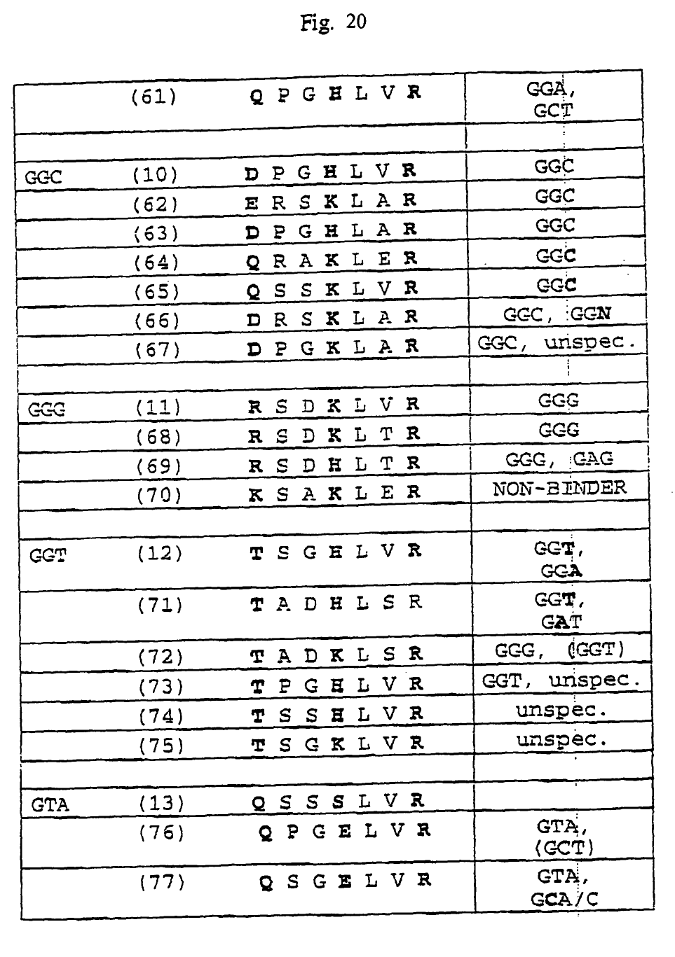

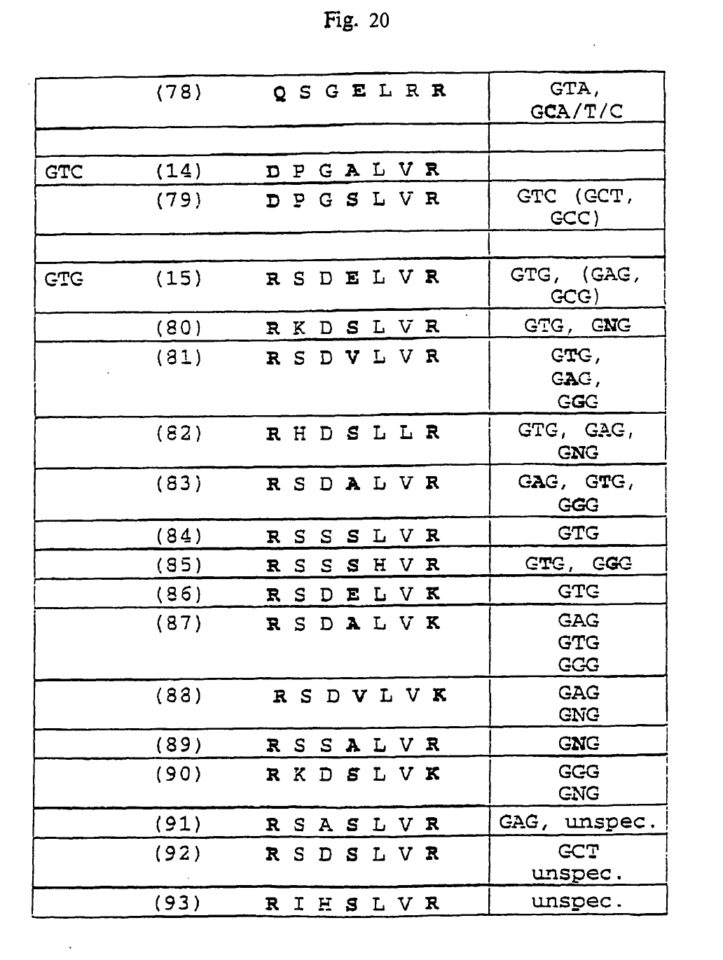

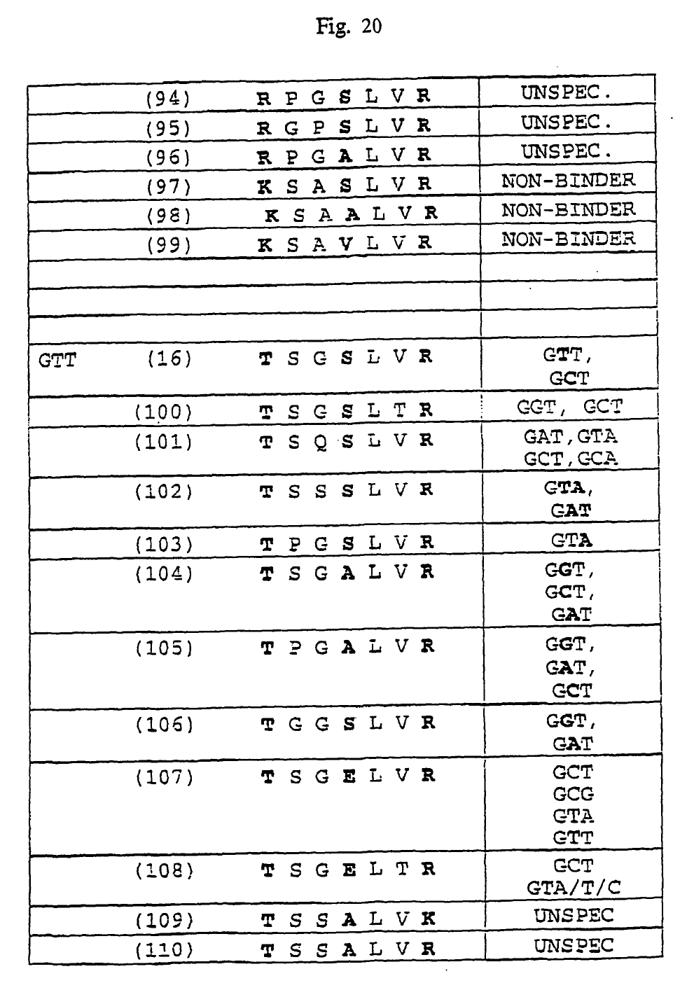

Means for making zinc finger binding domains that target GNN nucleotide targets as well as preferred such domains are described in U.S. Pat. No. 6,140,081, the entire disclosure of which is incorporated herein by reference. A list of preferred binding domains that target GNN can be found in FIG. 20.

### EXAMPLE 10

### CNN Zinc Finger Binding Domains

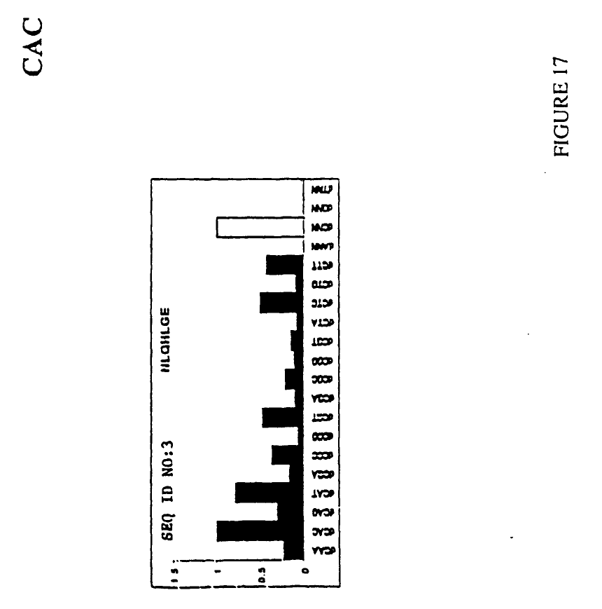

The present disclosure uses an approach to select zinc finger domains recognizing CNN sites by eliminating the target site overlap. First, finger 3 of C7 (RSD-E-RKR) (SEQ ID NO:50) binding to the subsite 5′-GCG-3′ was exchanged with a domain which did not contain aspartate in position 2 (FIG. 17). The helix TSG-N-LVR (SEQ ID NO:51), previously characterized in finger 2 position to bind with high specificity to the triplet 5′-GAT-3′, seemed a good candidate. This 3-finger protein (C7.GAT; FIG. 17A, lower panel), containing finger 1 and 2 of C7 and the 5′-GAT-3′-recognition helix in finger-3 position, was analyzed for DNA-binding specificity on targets with different finger-2 subsites by multi-target ELISA in comparison with the original C7 protein (C7.GCG; FIG. 17B). Both proteins bound to the 5′-TGG-3′ subsite (note that C7.GCG binds also to 5′-GGG-3′ due to the 5′ specification of thymine or guanine by Asp² of finger 3 which has been reported earlier.

The recognition of the 5′ nucleotide of the finger-2 subsite was evaluated using a mixture of all 16 5′-XNN-3′ target sites (X=adenine, guanine, cytosine or thymine). Indeed, while the original C7. GCG protein specified a guanine or thymine in the 5′ position of finger 2, C7.GAT did not specify a base, indicating that the cross-subsite interaction to the adenine complementary to the 5′ thymine was abolished. A similar effect has previously been reported for variants of Zif268 where Asp² was replaced by Ala² by site-directed mutagenesis [Isalan et al., (1997) Proc Natl Acad Sci USA 94(11), 5617-5621; Dreier et al., (2000) J. Mol. Biol. 303, 489-502]. The affinity of C7.GAT, measured by gel mobility shift analysis, was found to be relatively low, about 400 nM compared to 0.5 nM for C7.GCG [Segal et al., (1999) Proc Natl Acad Sci USA 96(6), 2758-2763], which may in part be due to the lack of the Asp² in finger 3.

Based on the 3-finger protein C7.GAT, a library was constructed in the phage display vector pComb3H [Barbas et al., (1991) Proc. Natl. Acad. Sci. USA 88, 7978-7982; Rader et al., (1997) Curr. Opin. Biotechnol. 8(4), 503-508]. Randomization involved positions −1, 1, 2, 3, 5, and 6 of the α-helix of finger 2 using a VNS codon doping strategy (V=adenine, cytosine or guanine, N=adenine, cytosine, guanine or thymine, S=cytosine or guanine). This allowed 24 possibilities for each randomized amino acid position, whereas the aromatic amino acids Trp, Phe, and Tyr, as well as stop codons, were excluded in this strategy. Because Leu is predominately found in position 4 of the recognition helices of zinc finger domains of the type Cys₂-His₂ this position was not randomized. After transformation of the library into ER2537 cells (New England Biolabs) the library contained 1.5×10⁹ members. This exceeded the necessary library size by 60-fold and was sufficient to contain all amino acid combinations.

Six rounds of selection of zinc finger-displaying phage were performed binding to each of the sixteen 5′-GAT-CNN-GCG-3′ biotinylated hairpin target oligonucleotides, respectively, in the presence of non-biotinylated competitor DNA. Stringency of the selection was increased in each round by decreasing the amount of biotinylated target oligonucleotide and increasing amounts of the competitor oligonucleotide mixtures. In the sixth round the target concentration was usually 18 nM, 5′-ANN-3′, 5′-GNN-3′, and 5′-TNN-3′ competitor mixtures were in 5-fold excess for each oligonucleotide pool, respectively, and the specific 5′-CNN-3′ mixture (excluding the target sequence) in 10-fold excess. Phage binding to the biotinylated target oligonucleotide was recovered by capture to streptavidin-coated magnetic beads. Clones were usually analyzed after the sixth round of selection.

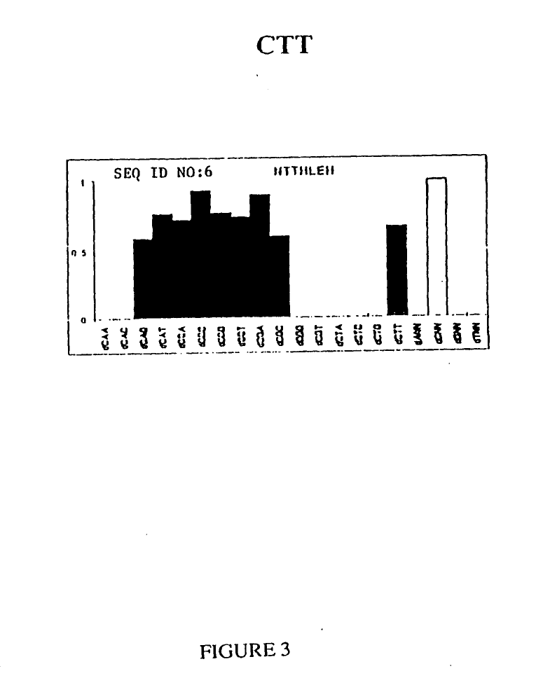

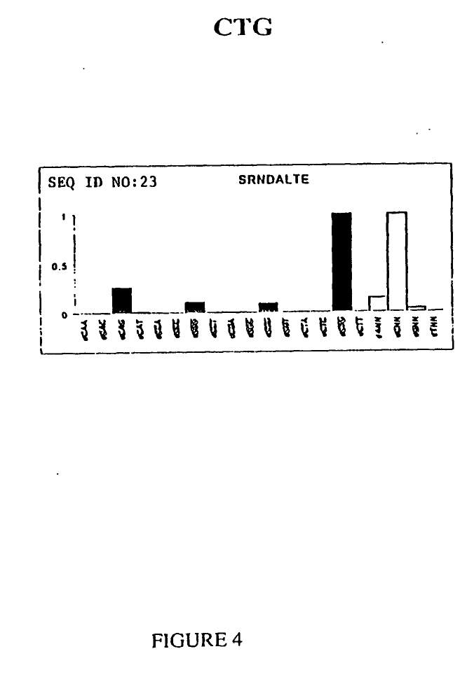

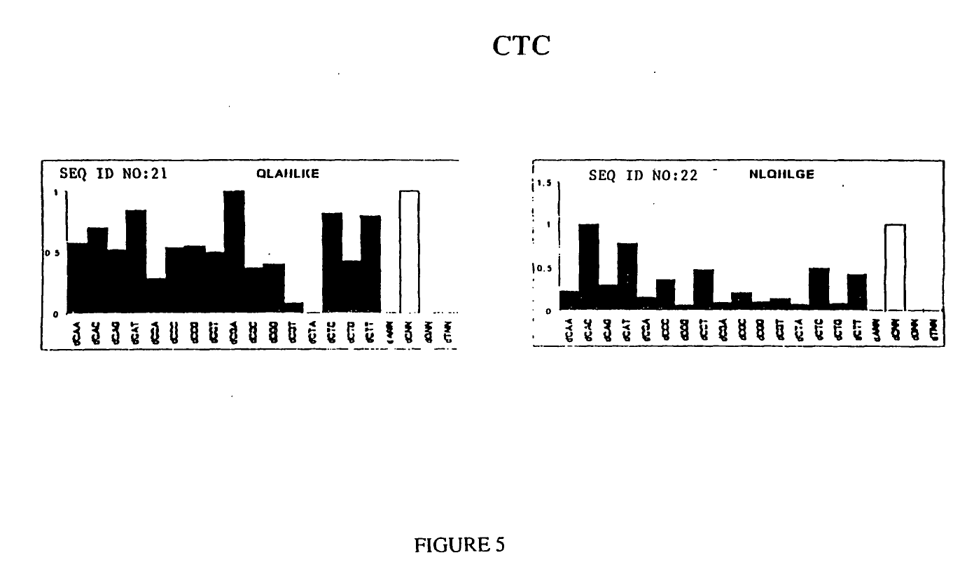

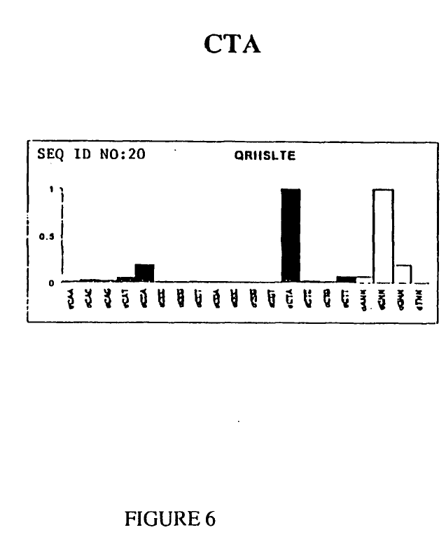

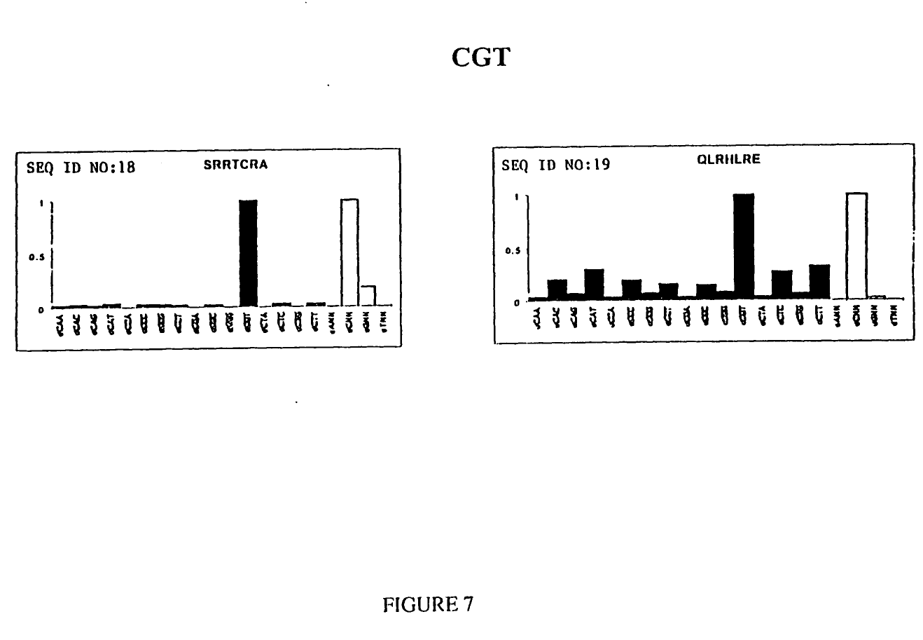

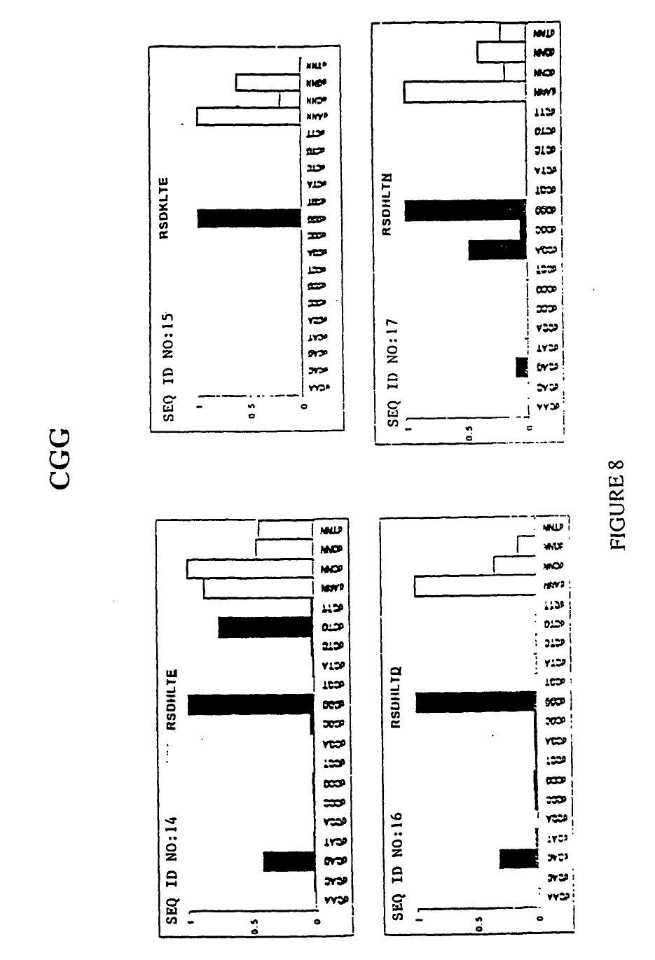

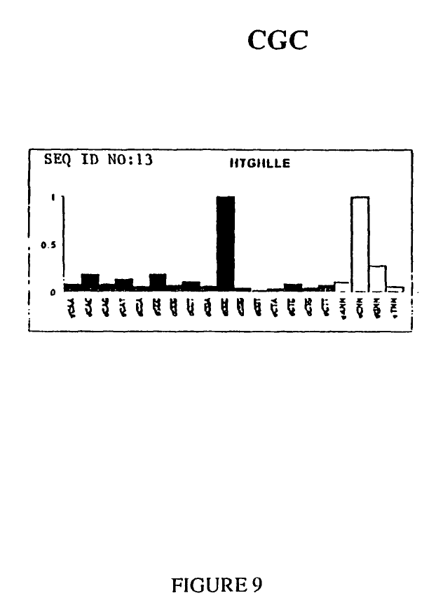

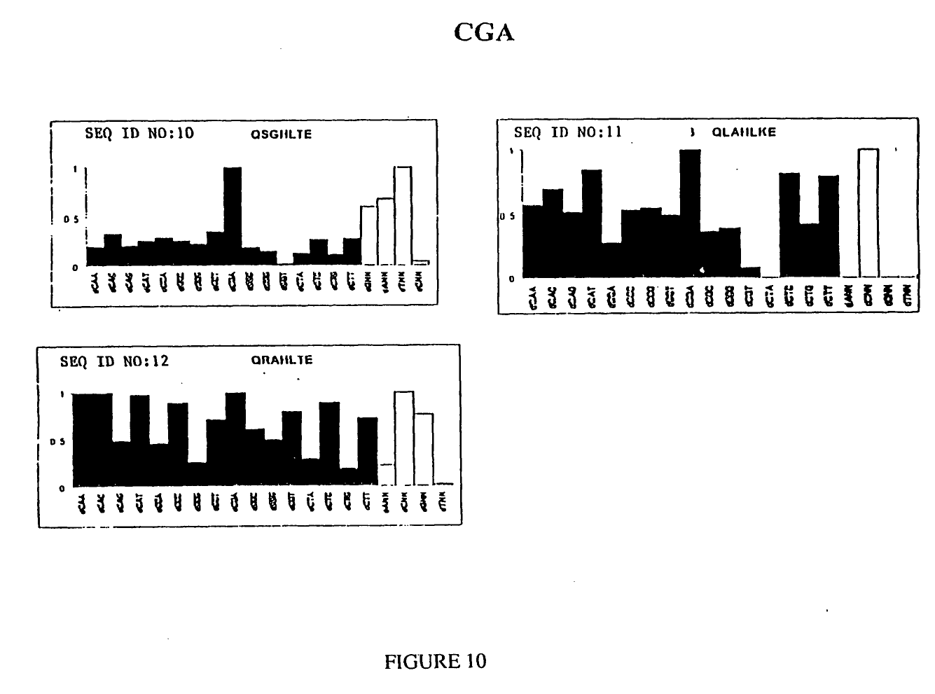

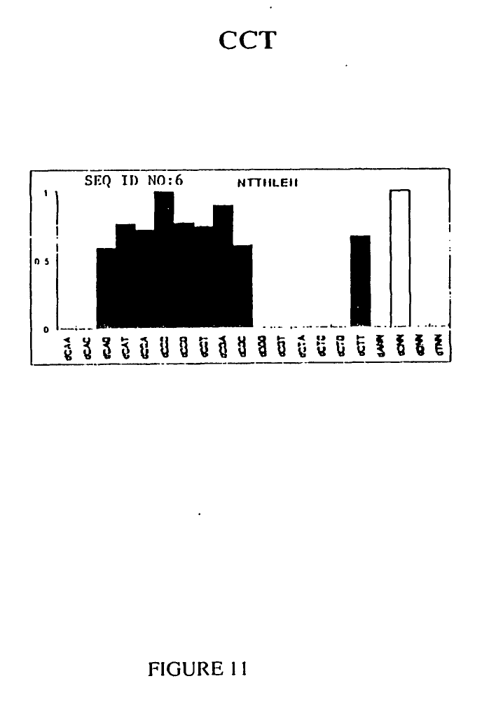

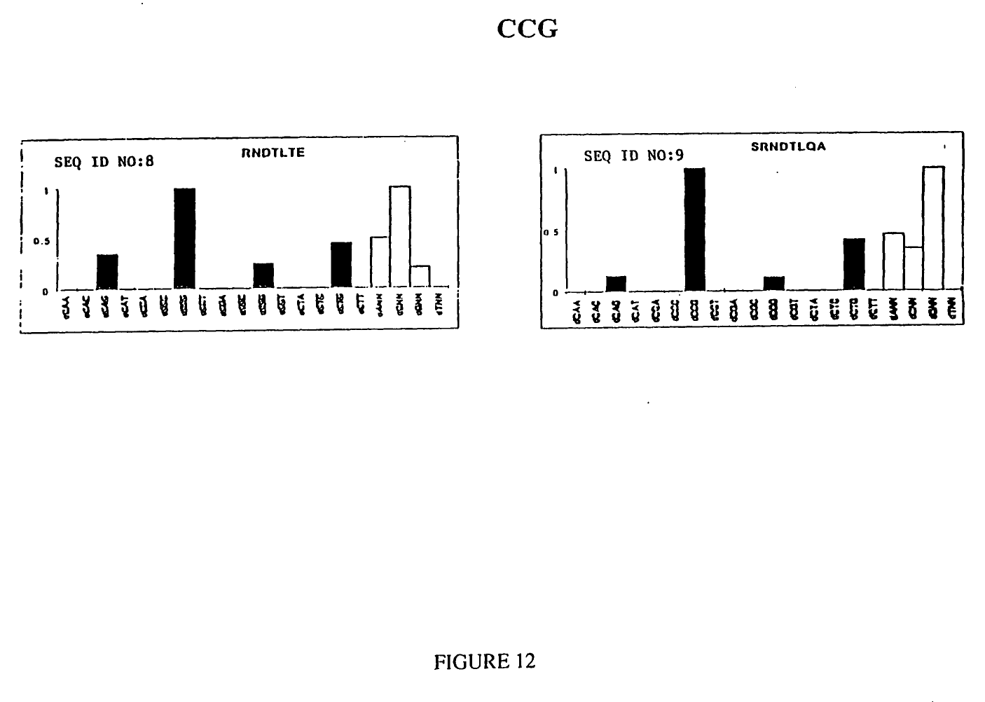

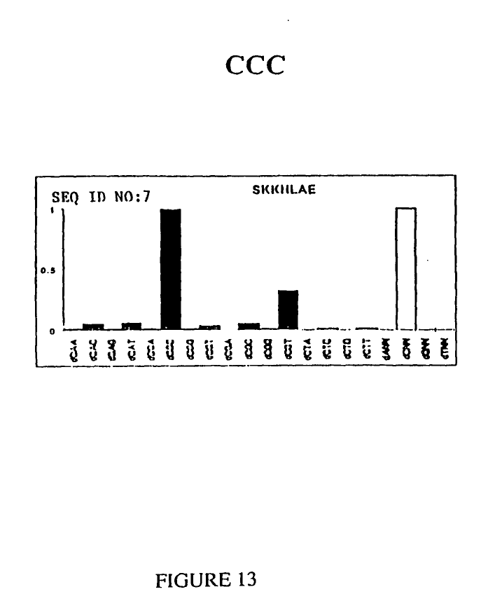

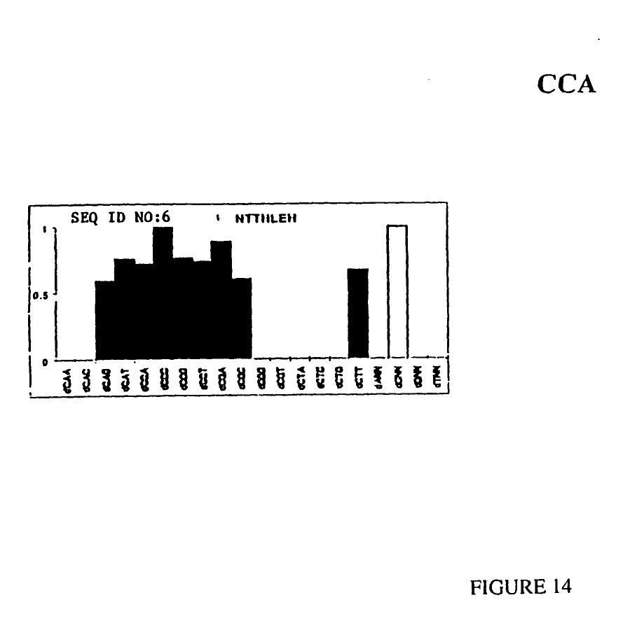

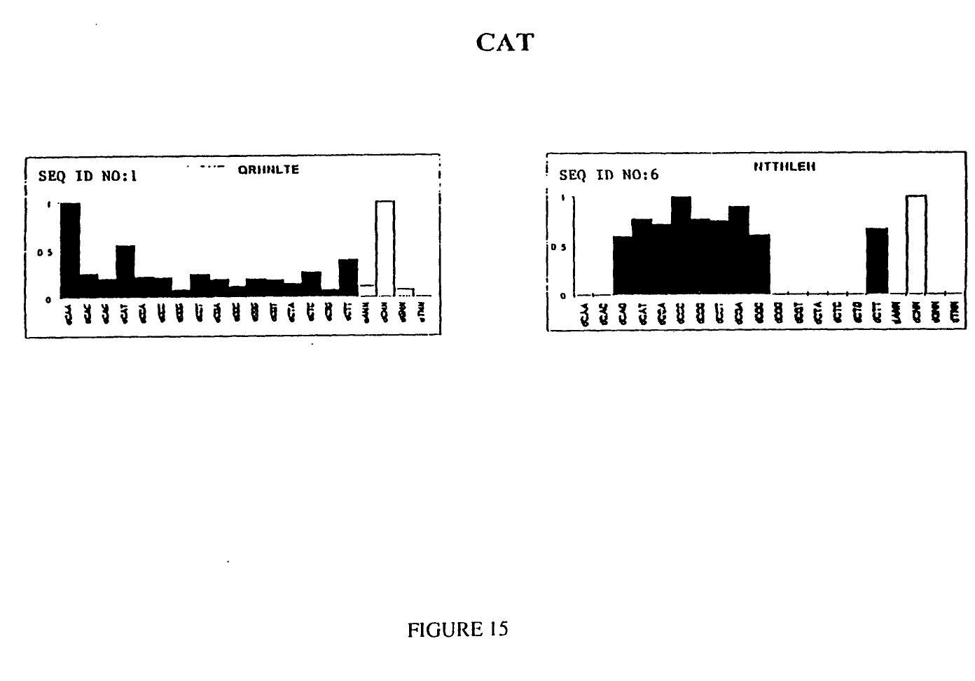

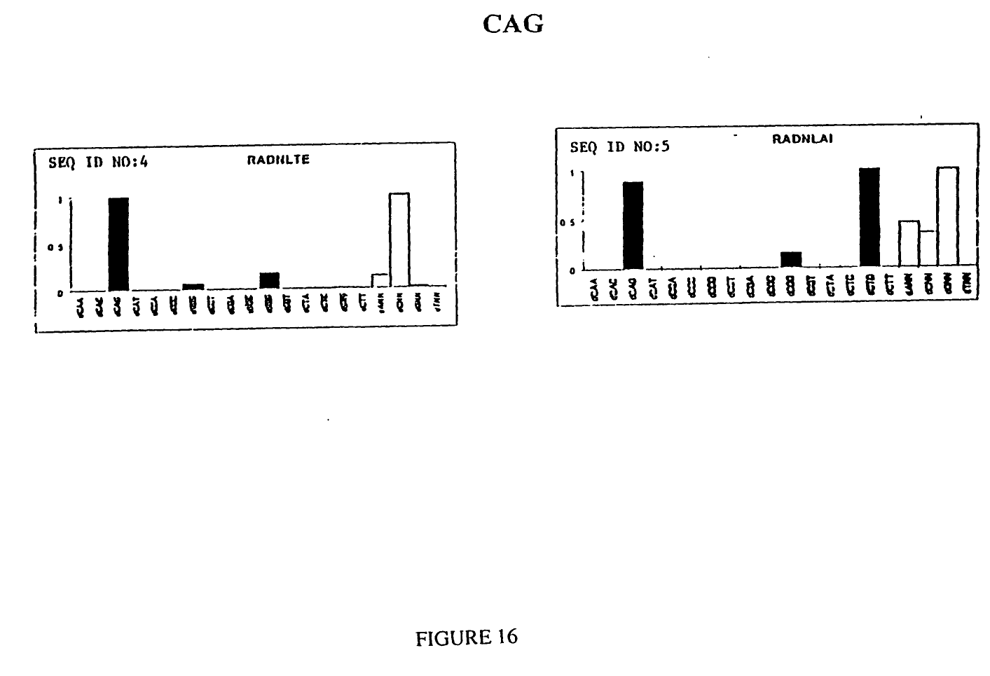

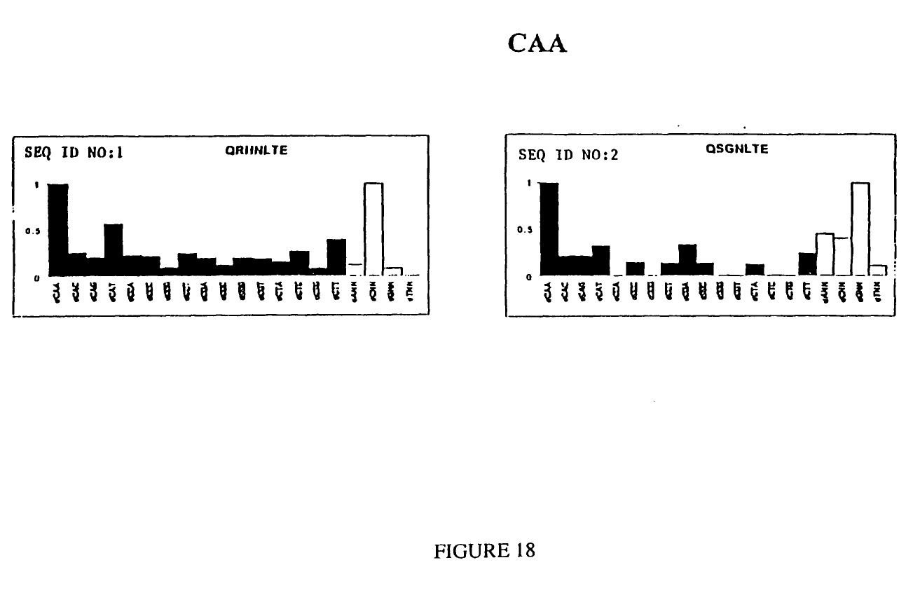

Preferred zinc finger DNA binding domains that target 5′-CNN-3′ are shown in FIGS. 2-18 (also see U.S. patent application Ser. Nos. 60/313,693 and 60/313,864, filed Aug. 20, 2001 and Aug. 21, 2001, the disclosures of which are incorporated herein by reference). At the top of the graphs depicted in FIGS. 3-18 are the amino acid sequences of the finger-2 domain (positions −2 to 6 with respect to the helix start) of the 3-finger protein analyzed. Black bars represent binding to target oligonucleotides with different finger-2 subsites: CAA, CAC, CAG, CAT, CCA, CCC, CCG, CCT, CGA, CGC, CGG, CGT, CTA, CTC, CTG or CTT. White bars represent binding to a set of oligonucleotides where the finger-2 subsite only differs in the 5′ position, for example for the domain binding the 5′-CAA-3′ subsite AAA, CAA, GAA, or TAA to evaluate the 5′ recognition. The height of each bar represents the relative affinity of the protein for each target, averaged over two independent experiments and normalized to the highest signal among the black or white bars. Error bars represent the deviation from the average.

### EXAMPLE 11

### ANN Zinc Finger Binding Domains

Zinc finger DNA binding domains that target 5′-ANN-3′ are made using the general procedures set forth above regarding domains that target CNN. Briefly, based on the 3-finger protein C7.GAT, a library was constructed in the phage display vector pComb3H [Barbas et al., (1991) Proc. Natl. Acad. Sci. USA 88, 7978-7982; Rader et al., (1997) Curr. Opin. Biotechnol. 8(4), 503-508]. Randomization involved positions −1, 1, 2, 3, 5, and 6 of the α-helix of finger 2 using a VNS codon doping strategy (V=adenine, cytosine or guanine, N=adenine, cytosine, guanine or thymine, S=cytosine or guanine). This allowed 24 possibilities for each randomized amino acid position, whereas the aromatic amino acids Trp, Phe, and Tyr, as well as stop codons, were excluded in this strategy. Because Leu is predominately found in position 4 of the recognition helices of zinc finger domains of the type Cys₂-His₂ this position was not randomized. After transformation of the library into ER2537 cells (New England Biolabs) the library contained 1.5×10⁹ members. This exceeded the necessary library size by 60-fold and was sufficient to contain all amino acid combinations.

Six rounds of selection of zinc finger-displaying phage were performed binding to each of the sixteen 5′-GAT-ANN-GCG-3′ biotinylated hairpin target oligonucleotides, respectively, in the presence of non-biotinylated competitor DNA. Stringency of the selection was increased in each round by decreasing the amount of biotinylated target oligonucleotide and increasing amounts of the competitor oligonucleotide mixtures. In the sixth round the target concentration was usually 18 nM, 5′-CNN-3′, 5′-GNN-3′, and 5′-TNN-3′ competitor mixtures were in 5-fold excess for each oligonucleotide pool, respectively, and the specific 5′-ANN-3′ mixture (excluding the target sequence) in 10-fold excess. Phage binding to the biotinylated target oligonucleotide was recovered by capture to streptavidin-coated magnetic beads. Clones were usually analyzed after the sixth round of selection.

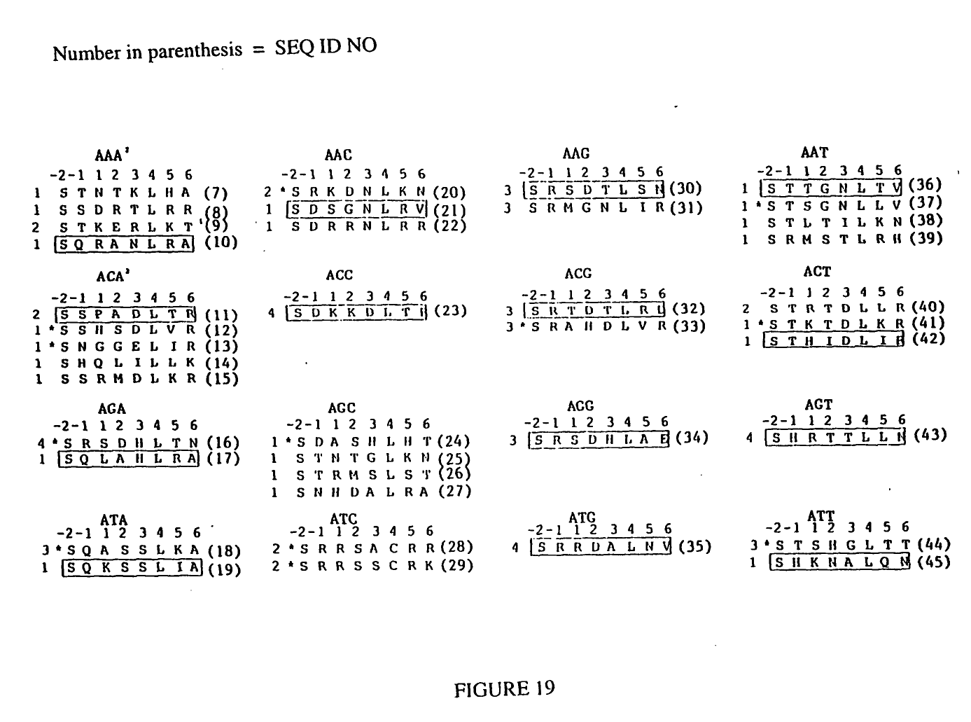

Preferred zinc finger DNA binding domains that target 5′-ANN-3′ are shown in FIG. 19 (also see U.S. patent application Ser. No.09/791,106, filed Feb. 21, 2001, the disclosure of which is incorporated herein by reference).

### EXAMPLE 12

### TNN Zinc Finger Binding Domains

Zinc finger DNA binding domains that target 5′-TNN-3′ are made using the general procedures set forth above regarding domains that target GNN. Preferred sequences of zinc finger protein DNA binding domains that target 5′-TNN-3′ nucleotide targets are QASNLIS (SEQ ID NO:52) (TNN), ARGNLKS (SEQ ID NO:53) (TAC), SRGNLKS (SEQ ID NO:54) (TAC), RLDNLQT (SEQ ID NO:55) (TAG), ARGNLRT (SEQ ID NO:56) (TAT), AND VRGNLRT (SEQ ID NO:57) (TAT).

What is claimed is:

1. A library of multimeric DNA binding polypeptides.

2. The library of claim 1 wherein the DNA binding polypeptides are zinc finger proteins having particular DNA binding domains.

3. The library of claim 1 wherein multimeric is dimeric.

4. The library of claim 1 wherein multimeric is trimeric.

5. The library of claim 1 wherein multimeric is quatrameric.

6. The library of claim 1 wherein multimeric is pentameric.

7. The library of claim 1 wherein multimeric is hexameric.

8. The library of claim 1 wherein at least one DNA binding polypeptide is non-naturally occurring.

9. The library of claim 2 wherein each zinc finger protein DNA binding peptide binds to a nucleotide sequence of the formula 5′-(GNN)-3′.

10. The library of claim 2 wherein each zinc finger protein DNA binding peptide binds to a nucleotide sequence of the formula 5′-(CNN)-3′.

11. The library of claim 2 wherein each zinc finger protein DNA binding peptide binds to a nucleotide sequence of the formula 5′-(ANN)-3′.

12. The library of claim 2 wherein each zinc finger protein DNA binding peptide binds to a nucleotide sequence of the formula 5′-(TNN)-3′.

13. The library of claim 2 wherein at least one zinc finger protein DNA binding peptide binds to a nucleotide sequence of the formula 5′-(GNN)-3′.

14. The library of claim 2 wherein at least one zinc finger DNA binding peptide binds to a nucleotide sequence of the formula 5′-(CNN)-3′.

15. The library of claim 2 wherein at least one zinc finger protein DNA binding peptide binds to a nucleotide sequence of the formula 5′-(ANN)-3′.

16. The library of claim 2 wherein at least one zinc finger protein DNA binding peptide binds to a nucleotide sequence of the formula 5′-(TNN)-3′.

17. The library of claim 1 wherein each multimeric DNA binding polypeptide is operatively linked to a functional moiety.

18. The library of claim 17 wherein the functional moiety is an enzyme.

19. The library of claim 17 wherein the functional moiety is a transcription regulating moiety.

20. The library of claim 19 wherein the transcription regulating moiety is an activator of transcription.

21. The library of claim 19 wherein the transcription regulating moiety is a repressor of transcription.

22. The library of claim 20 wherein the activator of transcription is VP16 or VP64.

23. The library of claim 21 wherein the repressor of transcription is KRAB or SID.

24. The library of claim 1 wherein the DNA binding polypeptides are linked using a peptide linker.

25. A collection of cells that contain the library of claim 1.

26. The cells of claim 25 that are plant cells.

27. The cells of claim 25 that are animal cells.

28. The cells of claim 25 that are bacterial cells.

29. The cells of claim 25 that are yeast cells.

30. The cells of claim 25 that are human cells.

31. A library of nucleotides that encode the multimeric DNA binding polypeptides of claim 1.

32. A collection of cells that contain the library of claim 31.

33. The cells of claim 32 that are plant cells.

34. The cells of claim 32 that are animal cells.

35. The cells of claim 32 that are bacterial cells.

36. The cells of claim 32 that are yeast cells.

37. The cells of claim 32 that are human cells.

38. A library of expression vectors that contain the nucleotides of claim 31.

39. A collection of cells that contain the library of claim 38.

40. The cells of claim 39 that are plant cells.

41. The cells of claim 39 that are animal cells.

42. The cells of claim 39 that are bacterial cells.

43. The cells of claim 39 that are yeast cells.

44. The cells of claim 39 that are human cells.

45. Plants generated from the cells of claim 40.

46. The expression vectors of claim 38 that are retroviral vectors.

47. The expression vectors of claim 38 that are adenoviral vectors.

48. The expression vectors of claim 38 that are T-DNA vectors.

49. A process of identifying a sequence of a transcriptional regulating site in a target gene in a cell, the process comprising the steps of:
a) transforming cells that contain the target gene with a library of nucleotides that encode a library of multimeric DNA binding polypeptides, each of which peptides is operatively linked to a transcription regulating moiety;
b) identifying the transformed cells that have an altered expression of the target gene;
c) extracting DNA from the cells of step (b);
d) sequencing the extracted DNA from step (c) to the identify the sequence of the multimeric DNA binding polypeptide that correlates with altered expression of the gene and the sequence of the transcriptional regulating site.

50. The process of claim 49 wherein transforming is accomplished by inserting the nucleotide library into expression vectors and transforming the cell with the vectors.

51. The method of claim 49 wherein at least one of the DNA binding polypeptides specifically binds to a nucleotide sequence of the formula 5′-(GNN)-3′.

52. The method of claim 49 wherein at least one of the DNA binding polypeptides specifically binds to a nucleotide sequence of the formula 5′-(ANN)-3′.

53. The method of claim 49 wherein at least one of the DNA binding polypeptides specifically binds to a nucleotide sequence of the formula 5′-(CNN)-3′.

54. The method of claim 49 wherein at least one of the DNA binding polypeptides specifically binds to a nucleotide sequence of the formula 5′-(TNN)-3′.

55. The method of claim 49 wherein the DNA binding peptide is a zinc finger protein DNA binding domain.

56. The method of claim 49 wherein the cell is a plant cell.

57. The method of claim 49 wherein the cell is a bacterial cell.

58. The method of claim 49 wherein the cell is a yeast cell.

59. The method of claim 49 wherein the cell is an animal cell.

60. The method of claim 49 wherein the cell is a human cell.


SEQUENCE LISTING (221 sequences)

SEQ ID NO: 1 - protein, 7 aa, Artificial Sequence
  Synthesized
QSSNLVR

SEQ ID NO: 2 - protein, 7 aa, Artificial Sequence
  Synthesized
DPGNLVR

SEQ ID NO: 3 - protein, 7 aa, Artificial Sequence
  Synthesized
RSDNLVR

SEQ ID NO: 4 - protein, 7 aa, Artificial Sequence
  Synthesized
TSGNLVR

SEQ ID NO: 5 - protein, 7 aa, Artificial Sequence
  Synthesized
QSGDLRR

SEQ ID NO: 6 - protein, 7 aa, Artificial Sequence
  Synthesized
DCRDLAR

SEQ ID NO: 7 - protein, 7 aa, Artificial Sequence
  Synthesized
RSDDLVK

SEQ ID NO: 8 - protein, 7 aa, Artificial Sequence
  Synthesized
TSGELVR

SEQ ID NO: 9 - protein, 7 aa, Artificial Sequence
  Synthesized
QRAHLER

SEQ ID NO: 10 - protein, 7 aa, Artificial Sequence
  Synthesized
DPGHLVR

SEQ ID NO: 11 - protein, 7 aa, Artificial Sequence
  Synthesized
RSDKLVR

SEQ ID NO: 12 - protein, 7 aa, Artificial Sequence
  Synthesized
TSGHLVR

SEQ ID NO: 13 - protein, 7 aa, Artificial Sequence
  Synthesized
QSSSLVR

SEQ ID NO: 14 - protein, 7 aa, Artificial Sequence
  Synthesized
DPGALVR

SEQ ID NO: 15 - protein, 7 aa, Artificial Sequence
  Synthesized
RSDELVR

SEQ ID NO: 16 - protein, 7 aa, Artificial Sequence
  Synthesized
TSGSLVR

SEQ ID NO: 17 - protein, 7 aa, Artificial Sequence
  Synthesized
QRSNLVR

SEQ ID NO: 18 - protein, 7 aa, Artificial Sequence
  Synthesized
QSGNLVR

SEQ ID NO: 19 - protein, 7 aa, Artificial Sequence
  Synthesized
QPGNLVR

SEQ ID NO: 20 - protein, 7 aa, Artificial Sequence
  Synthesized
DPGNLKR

SEQ ID NO: 21 - protein, 7 aa, Artificial Sequence
  Synthesized
RSDNLRR

SEQ ID NO: 22 - protein, 7 aa, Artificial Sequence
  Synthesized
KSANLVR

SEQ ID NO: 23 - protein, 7 aa, Artificial Sequence
  Synthesized
RSDNLVK

SEQ ID NO: 24 - protein, 7 aa, Artificial Sequence
  Synthesized
KSAQLVR

SEQ ID NO: 25 - protein, 7 aa, Artificial Sequence
  Synthesized
QSSTLVR

SEQ ID NO: 26 - protein, 7 aa, Artificial Sequence
  Synthesized
QSGTLRR

SEQ ID NO: 27 - protein, 7 aa, Artificial Sequence
  Synthesized
QPGDLVR

SEQ ID NO: 28 - protein, 7 aa, Artificial Sequence
  Synthesized
QGPDLVR

SEQ ID NO: 29 - protein, 7 aa, Artificial Sequence
  Synthesized
QAGTLMR

SEQ ID NO: 30 - protein, 7 aa, Artificial Sequence
  Synthesized
QPGTLVR

SEQ ID NO: 31 - protein, 7 aa, Artificial Sequence
  Synthesized
QGPELVR

SEQ ID NO: 32 - protein, 7 aa, Artificial Sequence
  Synthesized
GCRELSR

SEQ ID NO: 33 - protein, 7 aa, Artificial Sequence
  Synthesized
DPSTLKR

SEQ ID NO: 34 - protein, 7 aa, Artificial Sequence
  Synthesized
DPSDLKR

SEQ ID NO: 35 - protein, 7 aa, Artificial Sequence
  Synthesized
DSGDLVR

SEQ ID NO: 36 - protein, 7 aa, Artificial Sequence
  Synthesized
DSGELVR

SEQ ID NO: 37 - protein, 7 aa, Artificial Sequence
  Synthesized
DSGELKR

SEQ ID NO: 38 - protein, 7 aa, Artificial Sequence
  Synthesized
RLDTLGR

SEQ ID NO: 39 - protein, 7 aa, Artificial Sequence
  Synthesized
RPGDLVR

SEQ ID NO: 40 - protein, 7 aa, Artificial Sequence
  Synthesized
RSDTLVR

SEQ ID NO: 41 - protein, 7 aa, Artificial Sequence
  Synthesized
KSADLKR

SEQ ID NO: 42 - protein, 7 aa, Artificial Sequence
  Synthesized
RSDDLVR

SEQ ID NO: 43 - protein, 7 aa, Artificial Sequence
  Synthesized
RSDTLVK

SEQ ID NO: 44 - protein, 7 aa, Artificial Sequence
  Synthesized
KSAELKR

SEQ ID NO: 45 - protein, 7 aa, Artificial Sequence
  Synthesized
KSAELVR

SEQ ID NO: 46 - protein, 7 aa, Artificial Sequence
  Synthesized
RGPELVR

SEQ ID NO: 47 - protein, 7 aa, Artificial Sequence
  Synthesized
KPGELVR

SEQ ID NO: 48 - protein, 7 aa, Artificial Sequence
  Synthesized
SSQTLTR

SEQ ID NO: 49 - protein, 7 aa, Artificial Sequence
  Synthesized
TPGELVR

SEQ ID NO: 50 - protein, 7 aa, Artificial Sequence
  Synthesized
TSGDLVR

SEQ ID NO: 51 - protein, 7 aa, Artificial Sequence
  Synthesized
SSQTLVR

SEQ ID NO: 52 - protein, 7 aa, Artificial Sequence
  Synthesized
TSQTLTR

SEQ ID NO: 53 - protein, 7 aa, Artificial Sequence
  Synthesized
TSGELKR

SEQ ID NO: 54 - protein, 7 aa, Artificial Sequence
  Synthesized
QSSDLVR

SEQ ID NO: 55 - protein, 7 aa, Artificial Sequence
  Synthesized
SSGTLVR

SEQ ID NO: 56 - protein, 7 aa, Artificial Sequence
  Synthesized
TPGTLVR

SEQ ID NO: 57 - protein, 7 aa, Artificial Sequence
  Synthesized
TSQDLKR

SEQ ID NO: 58 - protein, 7 aa, Artificial Sequence
  Synthesized
TSGTLVR

SEQ ID NO: 59 - protein, 7 aa, Artificial Sequence
  Synthesized
QSSHLVR

SEQ ID NO: 60 - protein, 7 aa, Artificial Sequence
  Synthesized
QSGHLVR

SEQ ID NO: 61 - protein, 7 aa, Artificial Sequence
  Synthesized
QPGHLVR

SEQ ID NO: 62 - protein, 7 aa, Artificial Sequence
  Synthesized
ERSKLAR

SEQ ID NO: 63 - protein, 7 aa, Artificial Sequence
  Synthesized
DPGHLAR

SEQ ID NO: 64 - protein, 7 aa, Artificial Sequence
  Synthesized
QRAKLER

SEQ ID NO: 65 - protein, 7 aa, Artificial Sequence
  Synthesized
QSSKLVR

SEQ ID NO: 66 - protein, 7 aa, Artificial Sequence
  Synthesized
DRSKLAR

SEQ ID NO: 67 - protein, 7 aa, Artificial Sequence
  Synthesized
DPGKLAR

SEQ ID NO: 68 - protein, 7 aa, Artificial Sequence
  Synthesized
RSDKLTR

SEQ ID NO: 69 - protein, 7 aa, Artificial Sequence
  Synthesized
RSDHLTR

SEQ ID NO: 70 - protein, 7 aa, Artificial Sequence
  Synthesized
KSAKLER

SEQ ID NO: 71 - protein, 7 aa, Artificial Sequence
  Synthesized
TADHLSR

SEQ ID NO: 72 - protein, 7 aa, Artificial Sequence
  Synthesized
TADKLSR

SEQ ID NO: 73 - protein, 7 aa, Artificial Sequence
  Synthesized
TPGHLVR

SEQ ID NO: 74 - protein, 7 aa, Artificial Sequence
  Synthesized
TSSHLVR

SEQ ID NO: 75 - protein, 7 aa, Artificial Sequence
  Synthesized
TSGKLVR

SEQ ID NO: 76 - protein, 7 aa, Artificial Sequence
  Synthesized
QPGELVR

SEQ ID NO: 77 - protein, 7 aa, Artificial Sequence
  Synthesized
QSGELVR

SEQ ID NO: 78 - protein, 7 aa, Artificial Sequence
  Synthesized
QSGELRR

SEQ ID NO: 79 - protein, 7 aa, Artificial Sequence
  Synthesized
DPGSLVR

SEQ ID NO: 80 - protein, 7 aa, Artificial Sequence
  Synthesized
RKDSLVR

SEQ ID NO: 81 - protein, 7 aa, Artificial Sequence
  Synthesized
RSDVLVR

SEQ ID NO: 82 - protein, 7 aa, Artificial Sequence
  Synthesized
RHDSLLR

SEQ ID NO: 83 - protein, 7 aa, Artificial Sequence
  Synthesized
RSDALVR

SEQ ID NO: 84 - protein, 7 aa, Artificial Sequence
  Synthesized
RSSSLVR

SEQ ID NO: 85 - protein, 7 aa, Artificial Sequence
  Synthesized
RSSSHVR

SEQ ID NO: 86 - protein, 7 aa, Artificial Sequence
  Synthesized
RSDELVK

SEQ ID NO: 87 - protein, 7 aa, Artificial Sequence
  Synthesized
RSDALVK

SEQ ID NO: 88 - protein, 7 aa, Artificial Sequence
  Synthesized
RSDVLVK

SEQ ID NO: 89 - protein, 7 aa, Artificial Sequence
  Synthesized
RSSALVR

SEQ ID NO: 90 - protein, 7 aa, Artificial Sequence
  Synthesized
RKDSLVK

SEQ ID NO: 91 - protein, 7 aa, Artificial Sequence
  Synthesized
RSASLVR

SEQ ID NO: 92 - protein, 7 aa, Artificial Sequence
  Synthesized
RSDSLVR

SEQ ID NO: 93 - protein, 7 aa, Artificial Sequence
  Synthesized
RIHSLVR

SEQ ID NO: 94 - protein, 7 aa, Artificial Sequence
  Synthesized
RPGSLVR

SEQ ID NO: 95 - protein, 7 aa, Artificial Sequence
  Synthesized
RGPSLVR

SEQ ID NO: 96 - protein, 7 aa, Artificial Sequence
  Synthesized
RPGALVR

SEQ ID NO: 97 - protein, 7 aa, Artificial Sequence
  Synthesized
KSASLVR

SEQ ID NO: 98 - protein, 7 aa, Artificial Sequence
  Synthesized
KSAALVR

SEQ ID NO: 99 - protein, 7 aa, Artificial Sequence
  Synthesized
KSAVLVR

SEQ ID NO: 100 - protein, 7 aa, Artificial Sequence
  Synthesized
TSGSLTR

SEQ ID NO: 101 - protein, 7 aa, Artificial Sequence
  Synthesized
TSQSLVR

SEQ ID NO: 102 - protein, 7 aa, Artificial Sequence
  Synthesized
TSSSLVR

SEQ ID NO: 103 - protein, 7 aa, Artificial Sequence
  Synthesized
TPGSLVR

SEQ ID NO: 104 - protein, 7 aa, Artificial Sequence
  Synthesized
TSGALVR

SEQ ID NO: 105 - protein, 7 aa, Artificial Sequence
  Synthesized
TPGALVR

SEQ ID NO: 106 - protein, 7 aa, Artificial Sequence
  Synthesized
TGGSLVR

SEQ ID NO: 107 - protein, 7 aa, Artificial Sequence
  Synthesized
TSGELVR

SEQ ID NO: 108 - protein, 7 aa, Artificial Sequence
  Synthesized
TSGELTR

SEQ ID NO: 109 - protein, 7 aa, Artificial Sequence
  Synthesized
TSSALVK

SEQ ID NO: 110 - protein, 7 aa, Artificial Sequence
  Synthesized
TSSALVR

SEQ ID NO: 111 - DNA, 18 bp, Artificial Sequence
  Synthesized
nnnnnnnnnnnnnnnnnn

SEQ ID NO: 112 - DNA, 18 bp, Artificial Sequence
  Synthesized
nnnnnnnnnnnnnnnnnn

SEQ ID NO: 113 - DNA, 18 bp, Artificial Sequence
  Synthesized
gnngnngnngnngnngnn

SEQ ID NO: 114 - DNA, 18 bp, Artificial Sequence
  Synthesized
rnnrnnrnnrnnrnnrnn

SEQ ID NO: 115 - protein, 7 aa, Artificial Sequence
  Synthesized
QRNALAR

SEQ ID NO: 116 - protein, 7 aa, Artificial Sequence
  Synthesized
RKDNLKN

SEQ ID NO: 117 - protein, 7 aa, Artificial Sequence
  Synthesized
RSDHLTN

SEQ ID NO: 118 - protein, 7 aa, Artificial Sequence
  Synthesized
TTGNLTV

SEQ ID NO: 119 - protein, 7 aa, Artificial Sequence
  Synthesized
QAGHLAS

SEQ ID NO: 120 - protein, 7 aa, Artificial Sequence
  Synthesized
QSSNLAS

SEQ ID NO: 121 - protein, 7 aa, Artificial Sequence
  Synthesized
RSDHLTT

SEQ ID NO: 122 - protein, 7 aa, Artificial Sequence
  Synthesized
QLAHLRA

SEQ ID NO: 123 - protein, 7 aa, Artificial Sequence
  Synthesized
REDNLHT

SEQ ID NO: 124 - DNA, 78 bp, Artificial Sequence
  Synthesized
gaggaggaggaggaggtggcccaggcggccctcgagcccggggagaagccctatgcttgtccggaatgtggtaagtcc

SEQ ID NO: 125 - DNA, 39 bp, Artificial Sequence
  Synthesized
agatttgccgcactctgggcatttatacggtttttcacc

SEQ ID NO: 126 - DNA, 25 bp, Artificial Sequence
  Synthesized
taaatgcccagagtgcggcaaatct

SEQ ID NO: 127 - DNA, 36 bp, Artificial Sequence
  Synthesized
gccacattctggacatttgtatggcttctcgccagt

SEQ ID NO: 128 - DNA, 36 bp, Artificial Sequence
  Synthesized
actggcgagaagccatacaaatgtccagaatgtggc

SEQ ID NO: 129 - DNA, 63 bp, Artificial Sequence
  Synthesized
gaggaggaggaggagctggccggcctggccactagtttttttaccggtgtgagtacgttggtg

SEQ ID NO: 130 - DNA, 18 bp, Artificial Sequence
  Synthesized
tcaaagtagacggcatcg

SEQ ID NO: 131 - DNA, 22 bp, Artificial Sequence
  Synthesized
tcgtccagcgcgcgtcggcgcg

SEQ ID NO: 132 - DNA, 20 bp, Artificial Sequence
  Synthesized
cagaatttcgaccactgtgc

SEQ ID NO: 133 - DNA, 34 bp, Artificial Sequence
  Synthesized
ggtnnnnnnnnnaggttttcctnnnnnnnnnacc

SEQ ID NO: 134 - DNA, 52 bp, Artificial Sequence
  Synthesized
ggtnnnnnnnnnnnnnnnnnnaggttttcctnnnnnnnnnnnnnnnnnnacc

SEQ ID NO: 135 - DNA, 18 bp, Artificial Sequence
  Synthesized
ccggcgccaaaagagaga

SEQ ID NO: 136 - DNA, 25 bp, Artificial Sequence
  Synthesized
ctccttttccttcagctgaagtggt

SEQ ID NO: 137 - DNA, 21 bp, Artificial Sequence
  Synthesized
ccatgttcgtcatgggtgtga

SEQ ID NO: 138 - DNA, 20 bp, Artificial Sequence
  Synthesized
catggactgtggtcatgagt

SEQ ID NO: 139 - DNA, 45 bp, Artificial Sequence
  Synthesized
gnngnngnnnnnnnnnnnnnnnnnnnnnnnnnnnnngnngnngnn

SEQ ID NO: 140 - protein, 7 aa, Artificial Sequence
  Synthesized
RSDERKR

SEQ ID NO: 141 - protein, 7 aa, Artificial Sequence
  Synthesized
QASNLIS

SEQ ID NO: 142 - protein, 7 aa, Artificial Sequence
  Synthesized
ARGNLKS

SEQ ID NO: 143 - protein, 7 aa, Artificial Sequence
  Synthesized
SRGNLKS

SEQ ID NO: 144 - protein, 7 aa, Artificial Sequence
  Synthesized
RLDNLQT

SEQ ID NO: 145 - protein, 7 aa, Artificial Sequence
  Synthesized
ARGNLRT

SEQ ID NO: 146 - protein, 7 aa, Artificial Sequence
  Synthesized
VRGNLRT

SEQ ID NO: 147 - protein, 7 aa, Artificial Sequence
  Synthesized
NTTHLEH

SEQ ID NO: 148 - protein, 8 aa, Artificial Sequence
  Synthesized
SRNDALTE

SEQ ID NO: 149 - protein, 7 aa, Artificial Sequence
  Synthesized
QLAHLKE

SEQ ID NO: 150 - protein, 7 aa, Artificial Sequence
  Synthesized
NLQHLGE

SEQ ID NO: 151 - protein, 7 aa, Artificial Sequence
  Synthesized
QRHSLTE

SEQ ID NO: 152 - protein, 7 aa, Artificial Sequence
  Synthesized
SRRTCRA

SEQ ID NO: 153 - protein, 7 aa, Artificial Sequence
  Synthesized
QLRHLRE

SEQ ID NO: 154 - protein, 7 aa, Artificial Sequence
  Synthesized
RSDHLTE

SEQ ID NO: 155 - protein, 7 aa, Artificial Sequence
  Synthesized
RSDKLTE

SEQ ID NO: 156 - protein, 7 aa, Artificial Sequence
  Synthesized
RSDHLTD

SEQ ID NO: 157 - protein, 7 aa, Artificial Sequence
  Synthesized
HTGHLLE

SEQ ID NO: 158 - protein, 7 aa, Artificial Sequence
  Synthesized
QSGHLTE

SEQ ID NO: 159 - protein, 7 aa, Artificial Sequence
  Synthesized
QRAHLTE

SEQ ID NO: 160 - protein, 7 aa, Artificial Sequence
  Synthesized
RNDTLTE

SEQ ID NO: 161 - protein, 8 aa, Artificial Sequence
  Synthesized
SRNDTLQA

SEQ ID NO: 162 - protein, 7 aa, Artificial Sequence
  Synthesized
SKKHLAE

SEQ ID NO: 163 - protein, 7 aa, Artificial Sequence
  Synthesized
QRHNLTE

SEQ ID NO: 164 - protein, 7 aa, Artificial Sequence
  Synthesized
RADNLTE

SEQ ID NO: 165 - protein, 7 aa, Artificial Sequence
  Synthesized
RADNLAI

SEQ ID NO: 166 - protein, 7 aa, Artificial Sequence
  Synthesized
QSGNLTE

SEQ ID NO: 167 - protein, 8 aa, Artificial Sequence
  Synthesized
STNTKLHA

SEQ ID NO: 168 - protein, 8 aa, Artificial Sequence
  Synthesized
SSDRTLRR

SEQ ID NO: 169 - protein, 8 aa, Artificial Sequence
  Synthesized
STKERLKT

SEQ ID NO: 170 - protein, 8 aa, Artificial Sequence
  Synthesized
SQRANLRA

SEQ ID NO: 171 - protein, 8 aa, Artificial Sequence
  Synthesized
SSPADLTR

SEQ ID NO: 172 - protein, 8 aa, Artificial Sequence
  Synthesized
SSHSDLVR

SEQ ID NO: 173 - protein, 8 aa, Artificial Sequence
  Synthesized
SNGGELIR

SEQ ID NO: 174 - protein, 8 aa, Artificial Sequence
  Synthesized
SHQLILLK

SEQ ID NO: 175 - protein, 8 aa, Artificial Sequence
  Synthesized
SSRMDLKR

SEQ ID NO: 176 - protein, 8 aa, Artificial Sequence
  Synthesized
SRSDHLTN

SEQ ID NO: 177 - protein, 8 aa, Artificial Sequence
  Synthesized
SQLAHLRA

SEQ ID NO: 178 - protein, 8 aa, Artificial Sequence
  Synthesized
SQASSLKA

SEQ ID NO: 179 - protein, 8 aa, Artificial Sequence
  Synthesized
SQKSSLIA

SEQ ID NO: 180 - protein, 8 aa, Artificial Sequence
  Synthesized
SRKDNLKN

SEQ ID NO: 181 - protein, 8 aa, Artificial Sequence
  Synthesized
SDSGNLRV

SEQ ID NO: 182 - protein, 8 aa, Artificial Sequence
  Synthesized
SDRRNLRR

SEQ ID NO: 183 - protein, 8 aa, Artificial Sequence
  Synthesized
SDKKDLTR

SEQ ID NO: 184 - protein, 8 aa, Artificial Sequence
  Synthesized
SDASHLHT

SEQ ID NO: 185 - protein, 8 aa, Artificial Sequence
  Synthesized
STNTGLKN

SEQ ID NO: 186 - protein, 8 aa, Artificial Sequence
  Synthesized
STRMSLST

SEQ ID NO: 187 - protein, 8 aa, Artificial Sequence
  Synthesized
SNHDALRA

SEQ ID NO: 188 - protein, 8 aa, Artificial Sequence
  Synthesized
SRRSACRR

SEQ ID NO: 189 - protein, 8 aa, Artificial Sequence
  Synthesized
SRRSSCRK

SEQ ID NO: 190 - protein, 8 aa, Artificial Sequence
  Synthesized
SRSDTLSN

SEQ ID NO: 191 - protein, 8 aa, Artificial Sequence
  Synthesized
SRMGNLIR

SEQ ID NO: 192 - protein, 8 aa, Artificial Sequence
  Synthesized
SRTDTLRD

SEQ ID NO: 193 - protein, 8 aa, Artificial Sequence
  Synthesized
SRAHDLVR

SEQ ID NO: 194 - protein, 8 aa, Artificial Sequence
  Synthesized
SRSDHLAE

SEQ ID NO: 195 - protein, 8 aa, Artificial Sequence
  Synthesized
SRRDALNV

SEQ ID NO: 196 - protein, 8 aa, Artificial Sequence
  Synthesized
STTGNLTV

SEQ ID NO: 197 - protein, 8 aa, Artificial Sequence
  Synthesized
STSGNLLV

SEQ ID NO: 198 - protein, 8 aa, Artificial Sequence
  Synthesized
STLTILKN

SEQ ID NO: 199 - protein, 8 aa, Artificial Sequence
  Synthesized
SRMSTLRH

SEQ ID NO: 200 - protein, 8 aa, Artificial Sequence
  Synthesized
STRTDLLR

SEQ ID NO: 201 - protein, 8 aa, Artificial Sequence
  Synthesized
STKTDLKR

SEQ ID NO: 202 - protein, 8 aa, Artificial Sequence
  Synthesized
STHIDLIR

SEQ ID NO: 203 - protein, 9 aa, Artificial Sequence
  Synthesized
SHRTTLLNL

SEQ ID NO: 204 - protein, 8 aa, Artificial Sequence
  Synthesized
STSHGLTT

SEQ ID NO: 205 - protein, 8 aa, Artificial Sequence
  Synthesized
SHKNALQN

SEQ ID NO: 206 - protein, 7 aa, Artificial Sequence
  Synthesized
QRANLRA

SEQ ID NO: 207 - DNA, 18 bp, Artificial Sequence
  Synthesized
gcagggaaagtcaaagtg

SEQ ID NO: 208 - DNA, 18 bp, Artificial Sequence
  Synthesized
gtaggtgttggcgatgcg

SEQ ID NO: 209 - DNA, 18 bp, Artificial Sequence
  Synthesized
gacggtaaagccggggta

SEQ ID NO: 210 - DNA, 18 bp, Artificial Sequence
  Synthesized
gtaggttgggaaagagga

SEQ ID NO: 211 - DNA, 18 bp, Artificial Sequence
  Synthesized
tgagcggcttgaggggtc

SEQ ID NO: 212 - DNA, 18 bp, Artificial Sequence
  Synthesized
gctagagcagttgactaa

SEQ ID NO: 213 - DNA, 18 bp, Artificial Sequence
  Synthesized
gcagacggttaggacgcc

SEQ ID NO: 214 - protein, 7 aa, Artificial Sequence
  Synthesized
SDHLTNH

SEQ ID NO: 215 - DNA, 18 bp, Artificial Sequence
  Synthesized
gactgataagatgccgtg

SEQ ID NO: 216 - DNA, 18 bp, Artificial Sequence
  Synthesized
gagtgatgagaagatggc

SEQ ID NO: 217 - DNA, 18 bp, Artificial Sequence
  Synthesized
tgagcagtttgagccaaa

SEQ ID NO: 218 - DNA, 18 bp, Artificial Sequence
  Synthesized
gcagattaaggcggttaa

SEQ ID NO: 219 - DNA, 18 bp, Artificial Sequence
  Synthesized
gaaggagctgcggatggg

SEQ ID NO: 220 - protein, 7 aa, Artificial Sequence
  Synthesized
RSDTSSN

SEQ ID NO: 221 - protein, 7 aa, Artificial Sequence
  Synthesized
RSDTLSN